(19) United States
(12) Patent Application Publication
(10) Pub. No.: US 2002/0131604 A1
(43) Pub. Date: Sep. 19, 2002

(54) System and method for measuring and enhancing the quality of voice communication over packet-based networks

(76) Inventor: Gilbert A. Amine, Austin, TX (US)

Correspondence Address: AKIN, GUMP, STRAUSS, HAUER & FELD, L.L.P., 300 WEST 6TH STREET, SUITE 2100, AUSTIN, TX, 78701, US

(21) Appl. No.: 10/005,485

(22) Filed: Nov. 8, 2001

Related U.S. Application Data
(60) Provisional application No. 60/246,816, filed on Nov. 8, 2000.

(51) Int. Cl. H04R 29/00

(52) U.S. Cl. 381/58

(57) ABSTRACT

The present invention relates generally to testing and management of telecommunication networks and equipment. More specifically, the present invention relates to measuring, analyzing, and improving voice quality, reliability, and interoperability of packet-based voice communication systems.

### CROSS-REFERENCE TO RELATED APPLICATIONS

This application claims the benefit of U.S. Provisional Application No. 60/246,816.

The present application is based on and claims priority to U.S. Provisional Patent Application Serial No. 60/246,816 entitled “SYSTEM AND METHOD FOR MEASURING AND ENHANCING THE QUALITY OF VOICE COMMUNICATION OVER PACKET-BASED NETWORKS” (previously Attorney Docket No. ITB-018PR (491-19)), filed Nov. 8, 2000. All of such application is hereby incorporated herein by reference in its entirety, including any drawings and appendices, and is made part of the present U.S. Patent Application for all purposes.

The copyright owner has no objection to the reproduction by anyone of this patent document or the patent disclosure as it appears in the Patent and Trademark Office patent file or records, but otherwise reserves all rights under copyright laws and related laws pertaining to this work to the maximum extent allowable by such laws.

### FIELD OF THE INVENTION

This invention relates generally to testing and management of telecommunication networks and equipment. More particularly, the invention relates to improving voice quality, reliability, and interoperability of packet-based voice communication systems.

### BACKGROUND OF THE INVENTION

The traditional telephone network is based on assigning distinct lines or “circuits” to each connected call. When a user lifts a telephone handset and goes off-hook, the local central office provides a dial tone to the caller and assigns a “circuit” to him or to her. Once the desired number has been dialed, the call is switched to one or more intermediary central offices before finally reaching the destination. The Public Switched Telephone Network (PSTN), or the conventional telephone network as we know it today, relies on the use of circuit-switched connections.

The tremendous growth of the Internet and other computer networks has given rise to a new telephone technology, which is fundamentally different from the traditional PSTN. Known as voice over network (VON), this new technology relies on packet-oriented digital networks to deliver voice communication services as a digital stream. By sampling speech and recording it in digital form, encoding the digitized speech into packets, and transmitting the packets across computer networks, VON systems offer a lower cost alternative to PSTN due to their inherent efficiencies and lower bandwidth requirements.

An exemplary discussion of packet-based voice systems appears in APPENDIX A. Several communication protocols are used to deliver packet-based VON services. They include voice over the Internet Protocol (VoIP), voice over frame relay, voice over asynchronous transfer mode, voice over digital subscriber line and voice over cable. Discussions of packet-based computer networks for the transmission of voice and for providing telephone services appear in various documents, including U.S. patents.

A method and apparatus for increased quality of service over the Internet is taught by Williams et al. in U.S. Pat. No. 5,883,891, the disclosure of which is incorporated herein by reference in its entirety. Williams teaches the transmission of extra voice packets across multiple paths and reconstructing them at the receiving node. This method can result in improved speech quality performance due to overall statistical reduction in packet errors and delays. In practice, however, this method can be expensive, due to the substantial increase in packet communication, congestion, and cost. Furthermore, the method is inaccessible to VON users who do not have control over the selection of computer network paths for the routing of their voice calls. A user can select a service provider, but not a particular packet routing path. The paths used by different service providers can overlap, or can be affected by real-time loading conditions. Certain protocols delay the transmission of messages containing large files, by assigning those messages a lower transmission priority.

Specialized test equipment for the PSTN is available from a number of providers. The test equipment ranges from simple hand-held testers for service technicians to sophisticated testers for automated network management. These testers are intended to enable telephone technicians to verify the proper operation and quality of voice communication on the PSTN and to track down faults. For example, the Ameritec Corporation Model AM48 can be used to perform tests to check for the presence of dial tone, make test calls, and measure signal levels and noise. A brochure describing the Ameritec Corporation Model AM48 appears at APPENDIX B. The patent literature includes patents relating to methods and equipment for testing telephone lines.

Remote telephone test units, also known as responders, provide added flexibility to the testing of telephone lines and equipment by providing calibrated reference signals and by measuring and detecting received signals. These responders are designed primarily for performing tests over circuit-switched connections.

New testers have been developed for VON systems. An example is the Agilent Technologies Telegra, Model R-VQT J1981A, which measure objective speech quality and other communication parameters including delay, echo and Dual Tone Multiple Frequency (DTMF) performance. A data sheet on the Agilent Technologies Telegra, Model R-VQT J1981A appears in APPENDIX C. Testers such as the Agilent Telegra can provide useful overall end-to-end voice quality measurements and can detect problems.

Several products are available for testing traditional telephone apparatus that are used for connection to the PSTN; however, PSTN testers are not suitable for IP telephones. They cannot be used for troubleshooting subscriber or network equipment that are connected to VON or hybrid VON-PSTN networks.

The VON industry has developed a number of test standards for measuring the quality of voice communication across packet-based networks. These test standards include the International Telecommunication Union (ITU) Recommendation T-P.861 Perceptual Speech Quality Measure (PSQM), which objectively measures audio quality. A copy of ITU Recommendation T-P.861 appears as APPENDIX D. VON testers, such as the Agilent Telegra R-VQT J1981A, perform PSQM measurement by playing a standard coded speech file into a VON connection and recording and analyzing the received speech file at the other end of the connection.

The PSQM test and similar speech quality-oriented measurements cannot be performed by the Agilent Telegra tester on digital telephones such as the Cisco Systems IP Telephone Model 7910. The Cisco Systems IP Telephone Model 7910 is described in a brochure that appears in APPENDIX E. This limitation is due to the fact that digital telephones do not have a traditional analog telephone line interface. This limitation can prevent the measurement of voice quality on an end-to-end basis, as well as other performance and functional tests that may be needed. A further limitation faced by PSQM testers, such as the Agilent Telegra, is that they can check the overall quality of an end-to-end connection, but they cannot provide information as to where the problems may be occurring on the intermediary nodes. The tester must originate and complete the call from the same location.

Voice communication services that rely in part, or in whole, on packet-based VON present special challenges to technicians who are concerned with ensuring quality and reliability of such systems. Some of these challenges are enumerated below. For example, traditional PSTN test equipment and methods have limited value due to the fundamental difference between PSTN and VON systems, and the fact that traditional telephone lines are often replaced by an Ethernet connection between routers. There are no convenient intermediary test points available with which to track down and localize a problem. Voice quality can usually be measured at the starting and terminating points, but not at points in between. Packet-based networks use unpredictable routing of individual speech segments. Voice quality may change during the course of a call due to dynamic routing of packets over the data networks. The source of data errors, such as packet loss, delay, or jitter errors can be hard to pinpoint, due to the relatively large number of routers and gateways. VON calls that travel over one or more PSTN connection components along the route present added complexity for testing.

Some patents relating to telephony include U.S. Pat. No. 6,078,582 to Curry et al., U.S. Pat. No. 6,069,890 to White et al., U.S. Pat. No. 6,026,145 to Bauer et al., U.S. Pat. No. 6,026,087 to Mirashrafi et al., U.S. Pat. No. 6,014,379 to White et al., U.S. Pat. No. 5,946,392 to Tague, U.S. Pat. No. 5,897,615 to Harada, U.S. Pat. No. 5,883,891 to Williams, U.S. Pat. No. 5,754,624 to Sullivan et al., U.S. Pat. No. 5,726,984 to Kubler et al., U.S. Pat. No. 5,526,353 to Henley et al., U.S. Pat. No. 5,406,560 to Kondo et al., U.S. Pat. No. 5,148,429 to Kudo et al., U.S. Pat. No. 5,073,919 to Hagensick, U.S. Pat. No. 4,937,850 to Borbas et al., U.S. Pat. No. 4,907,267 to Gutzmer, U.S. Pat. No. 4,841,560 to Chan et al., U.S. Pat. No. 4,791,659 to Ross, U.S. Pat. No. 4,736,403 to McAlevey et al., U.S. Pat. No. 4,682,346 to Faith et al., U.S. Pat. No. 4,602,134 to Atkinson et al., U.S. Pat. No. 4,577,072 to Lulay, U.S. Pat. No. 4,453,247 to Suzuki et al., U.S. Pat. No. 4,323,738 to Merrick, and U.S. Pat. No. 4,232,195 to Bartelink, each of which is incorporated herein by reference in its entirety.

All of the foregoing notwithstanding, there remains a need to enable how to provide an optimized packet network-based connection by selecting among a number of carriers based on voice quality, reliability, cost, and other factors. There is a need to address some of the tests that are useful for maintaining the quality of packet-based communication. There is a need to perform quality and service-related tests over VON or hybrid VON-PSTN networks using a responder technology. There is a need to provide the ability to perform simultaneous testing over multiple possible computer networks and provide real-time quality measurements that may be used for call routing, or for changing the routing during the course of a call. There is a need to provide test apparatus and methods that can identify the location of a problem and that can suggest alternative routing of data packets, or changes to the communication equipment and software. There is a need for testers that support quality of service measurement from digital telephones and dynamic call routing.

### SUMMARY OF THE INVENTION

This invention describes a system and a method that enables a VON user to select the best service provider for a given call destination, based on service quality tests. Furthermore, this invention enables VON users transparently to change to a different service provider during the course of a call, should it become advantageous to do so due to quality, cost, or other factors. This invention provides for testing the performance and quality of VON and hybrid VON-PSTN voice services and equipment. This invention provides a system and a method for performing tests relating to the quality of voice communication between intermediary nodes of a digital telephone network, or between service providers.

The invention relates to a system and method for measuring and enhancing the quality of voice communication over packet-based networks. It is an object of this invention to provide a system including remote testers that perform PSQM and other telephony service measurements on an end-to-node, node-to-node, or end-to-end basis over VON networks. It is a further object of this invention to provide a system for performing PSQM testing and service troubleshooting when at least one end is a digital or IP telephone. It is yet a further object of this invention to provide a system and method to optimize the choice of VON service providers, by comparing the quality of their service to a destination, prior to placing the call. It is still a further object of this invention to provide a system for transparently changing service providers during the course of a call in response to a user input, or in response to changes in the quality of service, cost, or other factors. An additional object of this invention is to provide a system and method for recording, measuring, and simulating telephone line conditions and events at local and remote sites.

These and other objects may be achieved by providing a computer system equipped with audio and Ethernet, an analog telephony subsystem, an optional digital telephony subsystem, a front panel, and application software. In one embodiment, the computer system is a single board computer (SBC) based on a Pentium-class processor with system Random Access Memory, flash memory, hard drive, two serial ports, one VGA port, one keyboard port, and one expansion bus. The audio subsystem can be located on the SBC and may be a 16-bit full-duplex, SoundBlaster-compatible controller with independent stereo record and playback mixers. The sampling rate and size can be software-controlled. The Ethernet subsystem, made from two standard 10/100 Base-T Ethernet controllers, can be located on the SBC. The analog telephony subsystem has two analog ports that may be software-programmed as foreign exchange office (FXO), foreign exchange subscriber (FXS), or Ear and Mouth (E&M). A telephone handset and base set interface allows connection to a wide variety of telephone instruments, including digital telephones, for the purpose of troubleshooting and voice quality measurement. The digital telephony subsystem can be a communications controller with dual T1, E1, J1 framer and a cross connect switch. A line interface unit provides connection to short or long haul T1, E1, or J1 digital trunks. These ports may be configured for active termination or for high-impedance monitoring of the associated trunks. A high-speed buffered pulse code modulation (PCM) expansion bus is also provided for interface to external test equipment or network apparatus. The analog telephony subsystem also features an embedded microcontroller for controlling time slot assignment, signal generators, receivers, mixers, attenuators, and relays. The SBC which is used in this embodiment runs under a nonproprietary operating system, such as the Linux operating system. It can thus take advantage of the standard capabilities that are provided by this operating system, including multitasking operation, file management, and data networking. The application software, developed in the C programming language, provides the logical control for the desired tests, as well other functions including data logging and user interface. Software having the same features and capabilities can be written using other programming languages, as those of ordinary skill in the programming arts will recognize. In one embodiment, a front panel features a vacuum fluorescent display, two counters, and 14 buttons and LED's. The front panel provides user interface for stand-alone operation, and can provide for expanded capabilities.

The invention relates to a system based on a computing device, a DC and AC measurement subsystem, a waveform generation subsystem, a wide area networking communication subsystem, a telephone line interface or simulation subsystem, and a cross connect switch. The system can additionally include an added telephone handset interface and simulation subsystem, an added interface to one or more digital PCM lines, such as T1, or both an added telephone handset interface and simulation subsystem and an added interface to one or more digital PCM lines, such as T1. The system can further include a non-intrusive audio monitor of any of the analog or digital telephony channels through an internal speaker and a volume control knob.

The invention also relates to a system and method for interfacing to a telephone handset and a base unit. The invention relates to a system and method for simulating a telephone handset and a base unit. The invention relates to a system and method for injecting test signals through the handset port of a telephone set for the purpose of determining the quality of voice communication and call parameters on calls placed to and from that telephone set. The system and method can further include injecting previously recorded signals through the handset port of a telephone set for the purpose of determining the quality of voice communication and call parameters on calls placed to and from that telephone set. The system and method can further include injecting previously recorded digital signals through the handset port of a telephone set for the purpose of determining the quality of voice communication and call parameters on calls placed to and from that telephone set.

The invention relates to a system and method for measuring and recording signals through the handset port of a telephone for the purpose of determining the quality of voice communication and telephony service parameters on calls placed to and from that telephone set. The invention relates to a system and method for comparing audio levels that are present on the handset port with the ones present on other nodes of a VON, PSTN, or a hybrid VON-PSTN network for the purpose of optimizing the transmission levels, determining the best call routing, and measuring speech quality. The invention relates to a system and method for comparing speech signals which may be present on the handset port with speech signals that are generated by other devices that are connected to a VON, PSTN, or a hybrid VON-PSTN network.

The invention relates to a system and method for performing PSQM tests on a digital telephone through a handset port. The invention relates to a system and method for monitoring and measuring telephony DC and AC conditions and events on an FXS or FXO port. The invention relates to a system and method for recording and synchronizing telephony DC and AC events, indexing them, and saving them to a memory. The invention relates to a system and method capable of reproducing the saved telephony AC and DC conditions and events.

The invention relates to a system and method for modeling telephony DC and AC signals and events. The system and method can further include digital signal processing functions. The system and method can further include modification of the source impedance. The system and method can further include modification of the signal attenuation. The system and method can further include modification of the signal delay.

The invention relates to a system and method for encoding telephone line DC voltage or current by using voltage-to-frequency conversion resulting in an audio signal that can be recorded. The invention relates to a system and method for generating a DC voltage or current across a simulated telephone line by performing frequency-to-voltage conversion to a previously encoded audio signal. The invention relates to a system and method for simulating arbitrary telephony AC, DC, source impedance, noise, echo, conditions, or user events. The system and method can further include signal processing functions to determine possible improvements due to changes in some of the programmable characteristics of the corresponding telephony or computer network equipment. The system and method can further include digital signal processing techniques.

The invention relates to a system and method for measuring quality of speech, analyzing DTMF and other telephony signaling, or capturing line events at a remote location and communicating that information over computer networks. The system and method can include two or more testers, positioned at different geographic locations, for the purpose of monitoring the quality of speech and other communication parameters on voice-based computer networks. The invention relates to a system and method for generating one or more calls over different networks and deriving relative performance data from these calls. The user can compare the quality of service (speech quality, distortion, delays, jitter, echo, glitches, noise, etc.) between these networks under test. Each network may be a VON, a PSTN, or a hybrid VON-PSTN.

The invention relates to a system and method for dynamically monitoring speech and telephony service quality by generating test calls or sending test packets to other nodes and determining significant changes in the line quality due to network congestion, faults, and the like.

The invention relates to a system and method for optimizing VON service providers by performing short test calls over one or more VON, PSTN, or hybrid VONPSTN networks and selecting one carrier with the best price/performance. The invention relates to a system and method for enabling a VON user to switch to another service provider during the course of a call, by pressing one or more keys on the telephone keypad. The invention relates to a system and method for transparently monitoring the quality of one or more telephone calls in progress by checking for echoes, long pauses, or by performing speech recognition, and automatically searching for an alternative carrier with an improved voice quality. The system and method can further include alerting the current VON carrier that the call quality is degrading and requesting a better internal routing for the call. The system and method can further include switching to an alternative carrier and terminating the original call.

The invention relates to a system and method for encoding a “call-in-progress” header to enable alternative carriers to process voice packets that have been switched to them. The invention relates to a system and method for enabling alternative carriers to provision service, and bill for VON calls-in-progress that have been switched to them. The invention relates to a system and method for switching a call-in-progress to an alternative carrier, by creating a dummy conference call to one of the gateways using the alternate carrier, and ending the original call.

In one aspect, the invention relates to a testing system for measuring the quality of service of a voice communication in a packet-based network and for analyzing adherence to a communication protocol. The system comprises a connector adapted to make a connection to a test point in the packet-based network, and an analyzer that measures a quality of service of a voice signal transmitted over the packet-based network and analyzes adherence to a communication protocol at the test point. The analyzer comprises a computer, a configuration module that configures the computer to interface with the packet-based network, a quality of service analysis module that performs an analysis of the quality of service of the voice signal, a communications protocol analysis module that performs an analysis of adherence to the communication protocol, and a report generator that reports a result of the analysis.

In one embodiment, the system further comprises a recorder that records the signals transmitted by the packet-based network at the test point. In another embodiment the system still further comprises a reproduction unit that reproduces the recorded signal through the packet-based network at the test point to permit a determination of a speech quality.

In one embodiment, the quality of service analysis module comprises a module that tests a quality of service selected from a figure of merit for voice clarity, a figure of merit for voice intelligibility, a voice level, a power, a timing signal, and a delay. In one embodiment, the quality of service analysis module comprises a module that tests a telephony condition selected from an AC call-control signal, a DC call-control signal, a call progress tone, and a Custom Local Area Signaling Service (CLASS) signal. In one embodiment, the communication protocol analysis module comprises a module that tests a adherence to a communication protocol selected from an Internet protocol and a Voice over Internet Protocol. In one embodiment, the connector comprises a connector adapted to connect to a selected one of a telephone handset, a telephone base unit, a line card, and a router.

In one embodiment, the system further comprises a comparison module that compares signals obtained from two or more locations in the packet-based network. In one embodiment, the signals comprise signals selected from one of a figure of merit for voice clarity, a figure of merit for voice intelligibility, a voice level, a power, a timing signal, and a delay. In one embodiment, the signals comprise a signal obtained from a selected one of a telephone handset, a telephone base unit, a line card, and a router. In one embodiment, the signals comprise a signal obtained from a telephone handset and a signal obtained from a non-telephone device connected to a communication channel.

In one embodiment, the system further comprises a recording module that records a selected one of a DC impedance, an AC impedance, a noise, an echo, a waveform, a timing signal, and an event. In one embodiment, the system additionally comprises a non-volatile memory that maintains a record of a selected one of a DC impedance, an AC impedance, a noise, an echo, a waveform, a timing signal, and an event. In one embodiment, the system still further comprises a reproduction module that reproduces from a record a selected one of a DC impedance, an AC impedance, a noise, an echo, a waveform, a timing signal, and an event. In one embodiment, the system still further comprises a synchronizing module that synchronizes a first selected one of a waveform, a timing signal, and an event with a second selected one of a waveform, a timing signal, and an event. In one embodiment, the computer comprises a module that models mathematically a parameter of a programmable telephone equipment, the parameter selected from one of a DC impedance, an AC impedance, a noise, an echo, a waveform, a timing signal, and an event, the module calculating an improvement in performance of the programmable telephone equipment in response to a change in a programmable characteristic of the telephone equipment.

In one embodiment, the system still further comprises a transmitter module that sends over the packet-based network information about a selected one of a figure of merit for voice clarity, a figure of merit for voice intelligibility, a voice level, a power, a timing signal, a delay, a DC impedance, an AC impedance, a noise, an echo, a waveform, an event, an AC call-control signal, a DC call-control signal, a call progress tone, and a CLASS signal. In one embodiment, the system yet further comprises a tone and waveform generator that sends tones and selected waveforms over the packet-based network, and a synchronizing module that synchronizes a first selected one of a tone, a waveform, a timing signal, and an event with a second selected one of a tone, a waveform, a timing signal, and an event. In another embodiment, the system yet further comprises a recorder that records speech and signals, a digitizer that digitizes recorded speech and signals, and a scheduler that commands the transmitter to transmit the digitized recorded speech and signals as a file, the scheduler controlling and recording the time of transmission of the file, so that a delay and a degradation of the signal in one-way transmission can be analyzed. In another embodiment, the system further comprises a second transmitter that can generate a second call using a second network, a second analyzer that measures a quality of service of a voice signal transmitted over the second network and analyzes adherence to a communication protocol at the test point, the second analyzer comprising, a computer, a configuration module that configures the computer to interface with the second network, an quality of service analysis module that performs an analysis of the quality of service of the voice signal, a communications protocol analysis module that performs an analysis of adherence to the communication protocol, a report generator that reports a result of the analysis, and a comparator that compares the relative performance of the packet-based network and the second network. In one embodiment, the second transmitter comprises a transmitter that repeatedly generates the test calls and the second analyzer comprises an analyzer that repeatedly analyzes the test calls to monitor during a telephone call whether a significant change in quality of service takes place.

In one embodiment, the system still further comprises a routing selector that selects a route based at least in part on the quality of service measurement.

In one embodiment, the system still further comprises a receiver module that receives over the packet-based network information about a selected one of a figure of merit for voice clarity, a figure of merit for voice intelligibility, a voice level, a power, a timing signal, a delay, a DC impedance, an AC impedance, a noise, an echo, a waveform, an event, an AC call-control signal, a DC call-control signal, a call progress tone and a CLASS signal.

In one embodiment, the system still further comprises a receiver that detects and recognizes tones and selected waveforms transmitted over the packet-based network, and a synchronization detector that determines a synchronization between a first selected one of a tone, a waveform, a timing signal, and an event with a second selected one of a tone, a waveform, a timing signal, and an event.

In one embodiment, the system still further comprises a speech measurement module that measures a quality of service of a signal representative of speech, a signal measurement module that measures signal levels, an analyzer that detects and analyzes DTMF signals, and a display module that reports a selected result of one of a quality of service measurement, a signal level measurement, and a signal type analysis.

In one embodiment, the system still further comprises a second receiver that can accept a second call transmitted over a second network, a second analyzer that measures a quality of service of a voice signal transmitted over the second network and analyzes adherence to a communication protocol at the test point, the second analyzer comprising a computer, a configuration module that configures the computer to interface with the second network, an quality of service analysis module that performs an analysis of the quality of service of the voice signal, a communications protocol analysis module that performs an analysis of adherence to the communication protocol, a report generator that reports a result of the analysis, and a comparator that compares the relative performance of the packet-based network and the second network. In one embodiment, the second receiver comprises an receiver that repeatedly receives the test calls and the second analyzer comprises an analyzer that repeatedly analyzes the test calls to monitor during a telephone call whether a significant change in quality of service takes place.

In one embodiment, the system still further comprises a routing selector that selects a route based at least in part on the quality of service measurement.

The foregoing and other objects, aspects, features, and advantages of the invention will become more apparent from the following description.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a high-level system block diagram showing the interrelationship between and among subsystems of one embodiment of the invention.

FIG. 2 is a block diagram showing the functional interrelationship between components of the analog telephony board, according to one embodiment of the invention.

FIG. 3 is a block diagram showing the functional interrelationship between components of the digital telephony board, according to one embodiment of the invention.

FIG. 4 is a block diagram showing the functional interrelationship between components of the handset port, according to one embodiment of the invention.

FIG. 5 is a schematic diagram of the handset interface circuit, according to one embodiment of the invention.

FIG. 6 is a schematic block diagram of the telephone line event recorder, according to one embodiment of the invention.

FIG. 7 is a schematic block diagram of the telephone line event player, according to one embodiment of the invention.

FIG. 8 shows an exemplary network of service quality testers situated at different geographical locations, according to one embodiment of the invention.

FIG. 9 is an exemplary schematic diagram and associated discriminant table that illustrates the use of alternative VON carriers for improved service quality, according to one embodiment of the invention.

FIG. 10 is an exemplary block diagram that illustrates a system and method for using an alternative carrier during a call-in-progress without interrupting a VON connection, according to one embodiment of the invention.

FIG. 11 is an exemplary block diagram that illustrates a system and method for using an alternative carrier during a call-in-progress without interrupting a PSTN-based connection, according to one embodiment of the invention.

### DETAILED DESCRIPTION

The invention r elates to a system and method for measuring and enhancing the quality of voice communication over packet-based networks. The system includes a tester with flexible telephony and wide area networking interfaces and operating software. The tester can be portable. The tester is used to perform a variety of tests, including: telephone line simulation and testing; telephone apparatus testing; telephone event monitoring and simulation; voice quality testing; quality of service monitoring; and improving the quality of packet-based voice communication. The system is programmable and can act as a responder for remote or unsupervised operation. The invention contemplates a network of responders.

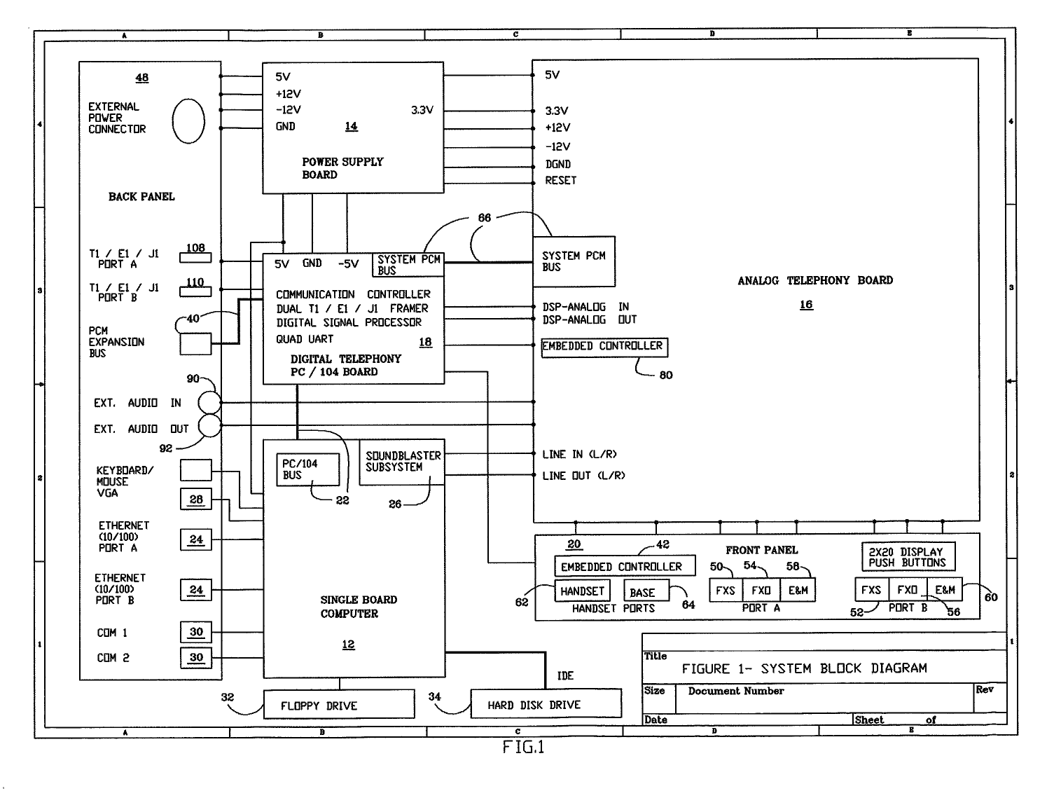

One embodiment includes a single board computer (SBC) 12, a power supply board 14, an analog telephony board 16, a digital telephony board 18, and a front panel board 20. FIG. 1 is a high-level block diagram showing the subsystems of such an embodiment and their interconnection.

The SBC 12 is a commercially available single board computer, such as the Advantech PCM-5823. The Advantech PCM-5823 is described in a summary data sheet that appears as APPENDIX F. A suitable SBC 12 for use in the system, such as the Advantech PCM-5823, may include a Pentium-class processor, RAM memory socket, a PC/104 expansion bus 22, two 10/100 Base-T Ethernet ports 24, SoundBlaster-compatible audio 26, VGA interface 28, two serial ports 30, one parallel port, floppy drive controllers 32 and hard drive controllers 34, and flash memory. A suitable SBC 12 preferably also features a standard personal computer Basic Input Output System (BIOS) software. PC/104 expansion cards enable the system to support new telephony or data communication interfaces, such as an Integrated Services Digital Network (ISDN), when such interfaces become available, allowing the system to be improved and upgraded as the technology of digital telephony advances. Those of ordinary skill in the computer hardware arts will recognize that other kinds of computers, having equivalent or better capabilities, may be substituted for the hardware described above.

The power supply board 14 provides internal power to all the hardware boards. It mates with an external power adapter, which provides regulated power, for example, power at 5 volts and +/−12 volts. A power switch is used to turn the power on and off, for example, by activating a relay on the board. The power supply board 14 also features 3.3 volts and 5 volts regulators, and surge protection. The power supply board 14 can be designed to provide power at other regulated voltages as necessary.

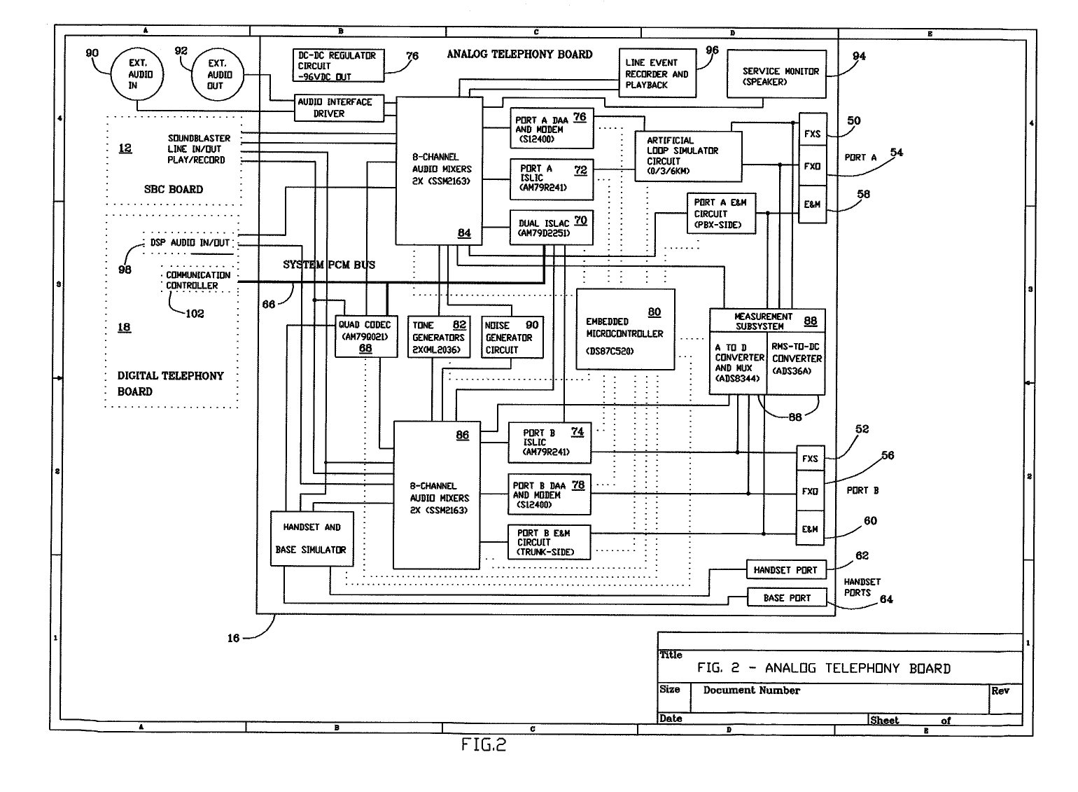

FIG. 2 shows a block diagram of an embodiment of an analog telephony board 16. The analog telephony board 16 includes the following subsystems, which are described in terms of particular embodiments using specific integrated circuit chips and the like, but which can equivalently be constructed using other equivalent circuitry.

Two FXS Ports (FXSA and FXSB), Each with Independently Programmable Parameters.

Each FXS port 50 and 52 can simulate a loop-start or a ground-start telephone line. Some of the programmable parameters that can be defined for a port include: DC loop-feed characteristics and current limit, ringing, loop supervision thresholds, 2-wire AC impedance, trans-hybrid balance, transmit and receive gains, and equalization. The FXS ports 50 and 52 are equipped with test capabilities, such as foreign voltage measurement, power-cross detection, ground fault detection, idle noise measurement, and loop resistance. The FXS ports 50 and 52 can transmit and receive DTMF tones, high frequency metering pulses (12 and 16 KHz) and Caller ID in the on-hook and off-hook states. In one embodiment, the FXS circuitry uses the Legerity Am79D2251 Dual Intelligent Subscriber Line Audio-Processing Circuit (ISLAC) IC 70 and two Am79R241 Intelligent Subscriber Line Interface Circuits (ISLIC) ICs 72 and 74. A DC-DC regulator circuit 76 provides −96 volts, which is required by the ISLIC 72 and 74 for battery and ring generation. The ISLAC 70 features a programmable time-slot assigner and a system PCM bus 66. The ISLIC/ISLAC chip set is controlled via a synchronous serial bus.

Two FXO Ports (FXOA and FXOB), Each Independently Programmable.

The AC and DC characteristics of the two FXO ports 54 and 56 can be software-adjusted for compatibility with any of the international standards. For example, these ports can be programmed to behave like U.S., German, French, or Japanese telephones, in accordance with FCC Part 68, RS-470 standards for the US, CTR-21 for Europe, or JATE for Japan. The FXO ports 54 and 56 feature Caller ID detection, DTMF generation and detection, call progress detection and low-speed modem communication capability. The FXO ports 54 and 56 also feature a measurement, tone detection, and recording capability in a non-intrusive high-impedance tap mode. In one embodiment, the FXO circuitry features two programmable data access arrangements (DAA) and the Silicon Laboratories Si2400 modem IC chip set. The audio in and out of each of the FXO ports 54 and 56 are sampled and converted into PCM by a time slot-programmable multi-channel CODEC, such as the Legerity Am79Q021 IC 156. Each FXO chip set is independently driven by an embedded microcontroller 42 via an asynchronous serial port.

Two E&M Ports (E&MA and E&MB)

One E&M port 58 is capable of simulating a PBX-side connection, while the second one 60 can simulate a trunk-side connection. Several standard 2-wire and 4-wire E&M configuration types are supported. The transmit and receive audio channels on the E&M ports 58 and 60 are accessible through audio mixers 84 and 86 and the system PCM bus 66.

A Telephone Handset Port

A preferred embodiment features a system for testing the handset 150 to base 152 connection of standard analog and digital telephones. In one embodiment, two RJ9 ports 62 and 64 are provided. The handset 150 can be disconnected from the base 152 of the telephone and connected to the handset port 62, and the base 152 can be connected to the base port 64. An acoustic test can be performed on the handset 150 so as to assess performance of the microphone and receiver by separating the handset 150 from the base 152 and simulating base drives and loads. The test can be done manually or by connecting an artificial head, it can run automatically. Acoustic testing of the base 152 can be performed by simulating the handset load and by generating and measuring test signals. The base 152 can be connected to one of the FXS ports 52 and 54 to automate this testing. If the base 152 is digital, the handset 150 can be used as the analog interface either directly to the port 62 or through an acoustic coupler.

The tester can perform end-to-end voice quality and other communication tests from the base connection to digital telephones. In this case, the base 152 is preferably connected to the PBX or computer network. All signaling available to the FXO ports 54 and 56 and FXS ports 50 and 52 is also available for base 152 and handset 150 testing as well as record capability. The handset 150 and base 152 transmit and receive audio can also be connected to the system PCM bus 66 through the quad CODEC IC 68. System PCM Bus

A time-division multiplexed PCM bus, preferably operating at 2.048 Mbps, is used to connect the transmit and receive channels on the two FXS 50 and 52, FXO 54 and 56, or E&M ports 58 and 60, the handset port 62 and the telephone base port 64. The SBC 12 SoundBlaster 26 audio play and record channels and other signaling sources on the tester can be connected to the PCM bus. The system PCM bus preferably supports up to 32 voice-band channels, or time slots. Time slot assignment on this bus is controlled by the embedded microcontroller discussed below.

Embedded Microcontroller

In one embodiment, an 8-bit microcontroller 80, such as the Dallas Semiconductor DS87C520 IC, is used to control the operation of tone generators 82, mixers 84 and 86, ISLICs 72 and 74, ISLAC 70 and the Si2400 ICs 76 and 78. The embedded microcontroller 80 incorporates non-volatile program memory and random access memory. It communicates with the SBC 12 using an asynchronous serial port. A command set is used to initialize and control the operation of the FXS 50 and 52 and FXO 54 and 56 IC's on the analog telephony board 16. The microcontroller 80 also controls the operation of relays and analog multiplexers that are used for signal routing and line or trunk signaling. The microcontroller 80 also controls the operation of the DC and AC measurement subsystem 88 and relays the measured data to the SBC 12.

Signal Generators and Mixers

In one embodiment, a white noise generator circuit 90 with programmable gain is used to provide noise impairments. The noise generator 90 is calibrated and is controlled by software. Noise can be generated at an absolute level or as a ratio referencing another signal. Two programmable sine wave generators, using, for example, the Micro Linear ML2036 IC are also used to generate tones ranging from 10 Hz to 20 kHz. The SoundBlaster subsystem 26 on the SBC 12 is also used to generate tones or to play back “wave” (.wav) files. One or more programmable audio mixers 84 and 86, such as, for example, the Analog Devices SSM2163 IC, are used to control the signal levels and to mix various sources of audio. The SSM2163s 84 and 86 are also used to generate calibration constants in software, so that all signal levels are controlled to within +/−1dB. A digital signal processor, which can be a commercially available programmable DSP IC on the digital telephony board 18, is also used to generate test signals and tones.

DC and AC Measurement Circuit

A measurement circuit 88 is provided which, in one embodiment, can be based on the Burr-Brown ADS8344 IC, which is an 8-channel, 16-bit analog-to-digital converter, and the Analog Devices AD536A RMS-to-DC converter IC. The measurement circuit 88 performs DC and true RMS AC measurements of all the analog signals that are transmitted or received on any of the ports.

External Audio

In one embodiment, a calibrated external audio input 90 permits the coupling of outside audio sources to any of the ports. A calibrated audio output 92 permits the coupling of any of the audio received from the ports, or internally generated by the analog telephony board 16, to an outside device. The audio output 92 features an audio amplifier that can drive up to 6 watts into a 4-ohm load. The external audio ports 90 and 92 may also be used to drive an external artificial head and mouth device for acoustic testing of telephones.

Audio Monitor

In one embodiment, a local amplifier and loudspeaker 94 can be used to monitor any of the telephone ports or internal audio channels, in addition to the external audio output port 92. A volume control knob on the front panel allows the user to set the desired volume, or to turn the audio monitor 94 off. This function is particularly useful for monitoring audio on the PCM bus.

Line Event Monitor

In one embodiment, a line event monitor circuit 96 that can be connected to FXOA 54, FXOB 56, FXSA 50, or FXSB 52 permits the recording of telephone line or trunk audio and line DC voltage using the stereo recording capability of the SoundBlaster subsystem 26. In an exemplary method of operation, telephone line audio is sampled and encoded by the SoundBlaster system 26 into a left channel 312 audio signal. DC levels are first encoded into corresponding tones using a voltage-to-frequency converter 310, such as, for example, the Burr-Brown VFC32 voltage-to frequency converter IC, and then encoded and recorded by the SoundBlaster subsystem 26 as right channel 314 audio. The resulting stereo wave file, line audio on the left channel 312 and line DC on the right channel 314, is saved on the SBC's 12 non-volatile memory. The line event monitor 96 can also play back the recorded wave file and re-generate the telephone events that have been recorded, by using the audio playback capability of the SoundBlaster subsystem 26 and the frequency-to-voltage conversion capability of the VFC32.

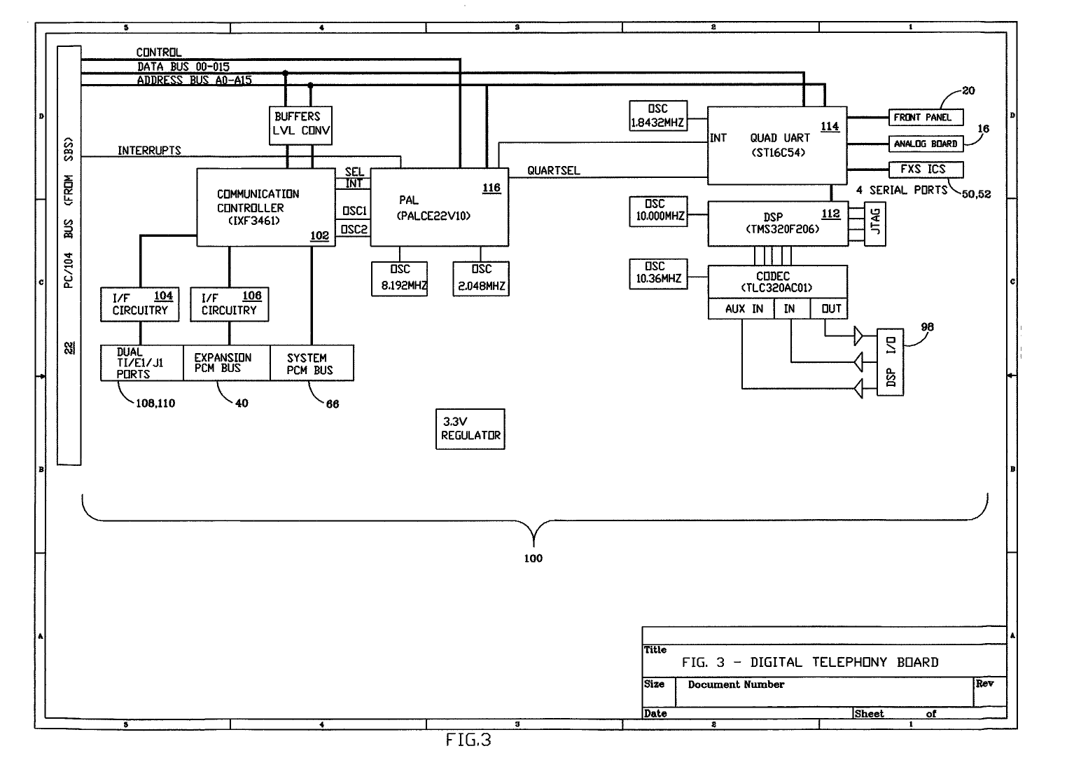

As illustrated in FIG. 3, in one embodiment the digital telephony board 18 is a PC/104-compatible plug-in module that includes the following components. As is recognized by those of ordinary skill in the circuitry arts, alternative embodiments that have substantially the same capabilities are possible.

A Communication Controller

In one embodiment, the communication controller 102 is the Intel IXF3461 IC. The Intel IXF3461 IC 102 features two line interface units 104 and 106, two independent T1/E1/J1 framers 108 and 110, six high-level data link (HDLC) controllers and a cross-connect switch. The IXF3461 IC 102 also features a microprocessor bus interface for control, and two or more PCM busses. The IXF3461 IC works from a single reference clock input and generates all the required T1/E1 clocks internally.

The System PCM Bus

In one embodiment, the System PCM Bus is used to communicate with the analog telephony board 16. The system PCM Bus allows the exchange of audio between any of the ports on the analog telephony board 16, including the SoundBlaster 26, external audio channels 90 and 92, the T1/E1/J1 digital trunks 108 and 110, and the expansion PCM bus 40.

The Expansion PCM Bus

The Expansion PCM Bus 40 is a dedicated high-speed PCM bus that can be connected to outside test equipment or to networking equipment, allowing the exchange of audio channels, or time slots, with the analog and digital telephony boards.

The Digital Trunk Interface Circuit

The Digital Trunk Interface circuit 104 allows the digital telephony board 18 to communicate with one or two T1, E1, or J1 digital trunks 108 and 110. Short and Long haul connections are supported. Surge and power fault protection devices are provided.

A Digital Signal Processor (DSP)

In one embodiment, a Texas Instruments TMS320F206 IC 112 with preprogrammed software is provided on the digital telephony board 18. The TMS320F206 112 can be used to generate or measure a variety of analog signals and for limited speaker-independent speech recognition. Its analog input and output 98 fcan be connected to the analog telephony board 16.

A Quad Universal Asynchronous Receiver and Transmitter (UART)

In one embodiment, the Exar ST16C554 IC 114 is used for communication between the SBC 12 and the front panel board 20 embedded microcontroller, analog telephony board 16 embedded microcontroller, DSP 112, and the FXO ICs 54 and 56 on the analog telephony board 16. The Quad UART 114 features software selectable baud rate generation, and transmit and receive buffer memory.

A Programmable Array Logic (PAL)

In one embodiment, the Lattice Semiconductor PALCE22V1 IC 116 is used to decode the address and interrupts for the digital telephony card from the PC/104 bus 22 of the SBC 12.

A Front Panel Board

In one embodiment, the front panel board 20 includes an embedded microcontroller, such as the Philips P89C52, a vacuum fluorescent display, having, for example, 2 lines of 20 characters each, two 4-digit counters, 14 keys, and LED's. The front panel allows a user to configure and operate the tester in the absence of a VGA monitor and keyboard or keypad, or to provide added capabilities. The front panel board 20 permits the tester to be compact, self-contained, light, and portable (i.e., able to be used in a field or remote installation without additional input and output components).

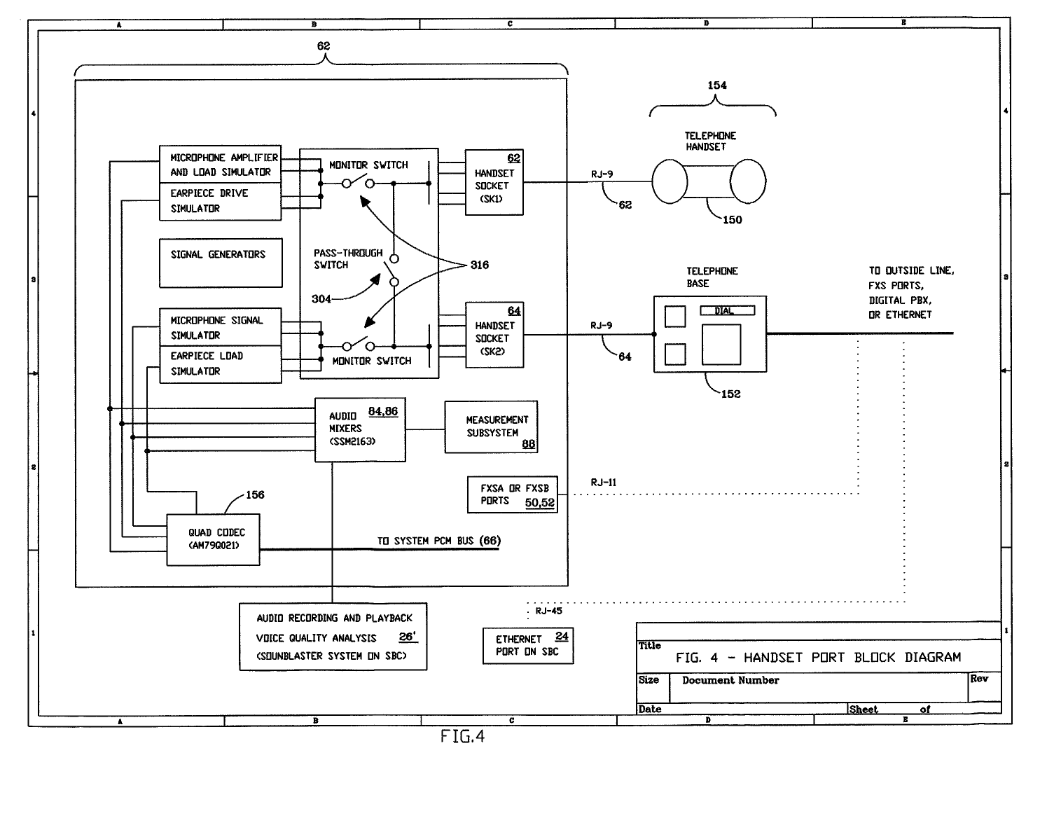

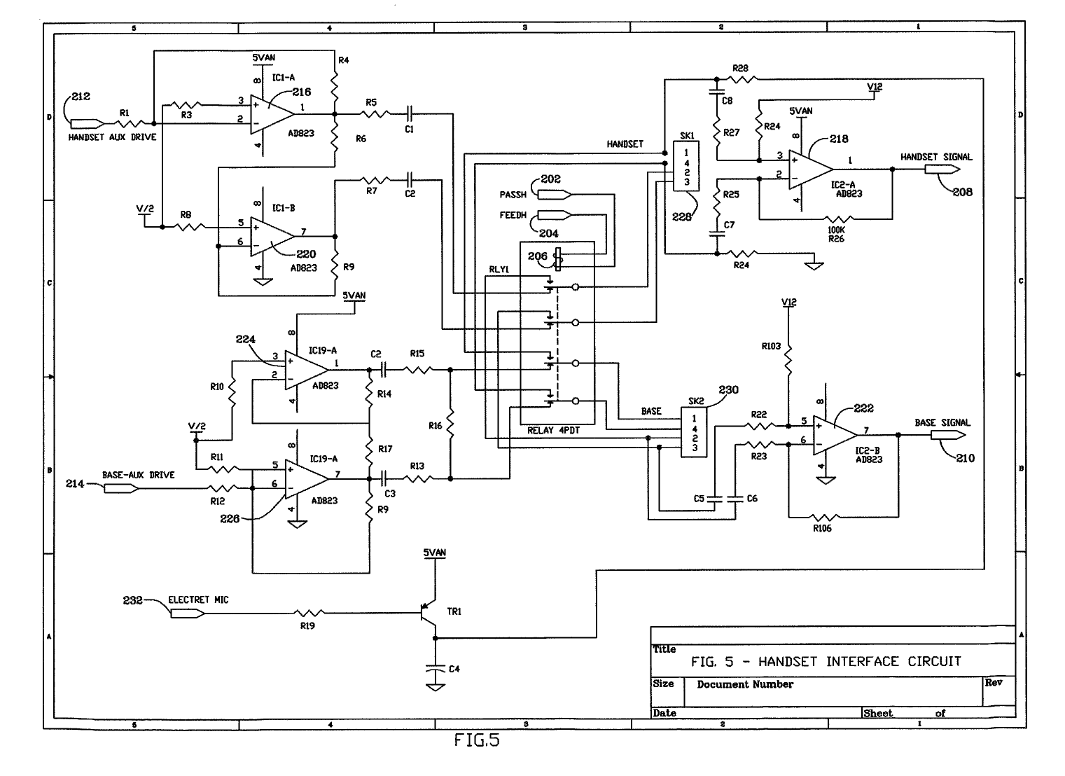

FIG. 4 provides a block diagram of the handset port 62. FIG. 5 shows a circuit schematic of one embodiment for this port or interface. The handset port 62 includes two RJ-9 modular connectors 62 and 64 accessible on the front of the tester. One port 62 is labeled “HANDSET” for interface to the handset 150, while the second one 64 is labeled “BASE” for interface to the base 152 of the telephone set under test. Under software control, the connection between the handset 150 and base 152 of the telephone under test may be broken and tests performed on each of them, or they may be placed in a pass-though mode. The wiring in the handset port 62 is based on the standard US telephone with pins 1 and 4 assigned to the microphone and pins 2 and 3 assigned to the speaker. Other wiring configurations can be supported with an external converter. If an Electret-type microphone 232 is used, a microphone supply switch is provided with pin 1 taken positive.

Referring to FIG. 5, a signal applied to the terminals labeled PASSH 202 and FEEDH 204 powers the electromagnet in a four-pole double throw relay labeled RLY1 206. If a signal of one polarity is applied (i.e., the “pass” condition), the relay switches to one position that causes the respective pins 1 through 4 of the RJ-9 connector labeled HANDSET 62 to be connected to the RJ-9 connector labeled BASE 64 via the relay RLY1 206. If the other polarity signal is applied (i.e., the “feed condition”), the terminal HANDSET SIGNAL 208 is connected via RLY1 206 to the terminal HANSET AUX DRIVE 212, and the terminal BASE SIGNAL 210 is connected via RLY1 206 to the terminal BASE AUX DRIVE 214.

In the feed mode, the connection between the handset 150 and base 152 is broken. Signals from a variety of sources, including SoundBlaster 26 wave files, can be connected to the signal labeled HANDSET AUX DRIVE 212 and can be driven to the handset 150 speaker for functional or acoustic testing. The operational amplifier IC1-A 216 simulates the base speaker drive. The signal level and frequency are software controllable. The signal can include single or multiple tones or a wave file from the SoundBlaster subsystem 26 of the SBC 12. The signal from the microphone is amplified through the operational amplifier IC2-A 218 and can be measured, monitored, or recorded for later analysis. This feature can be used for full acoustic testing.

The BASE AUX DRIVE signal path is also routed through IC1-B 220 to the base telephone's microphone input for acoustic and functional tests. The signal from the base speaker drive is amplified through operational amplifier IC2-B 222 and may be recorded or monitored/measured in real time.

In the pass-through mode, the connection between the handset 150 and the base 152 is made via the relay RLY1 206. The signal drives are no longer connected but a high-impedance is left on for both microphone and receiver for recording and measurement.

The handset port 62 of this invention allows the tester to verify the proper operation of a telephone handset 150, optimize the transmission and receive levels from the telephone set 154, and generate and receive test calls. The handset port 62 is a suitable access point for performing qualitative voice quality tests, for example by coupling analog signals and audio wave files into the base unit for transmission across PSTN, VON, or hybrid VON-PSTN networks.

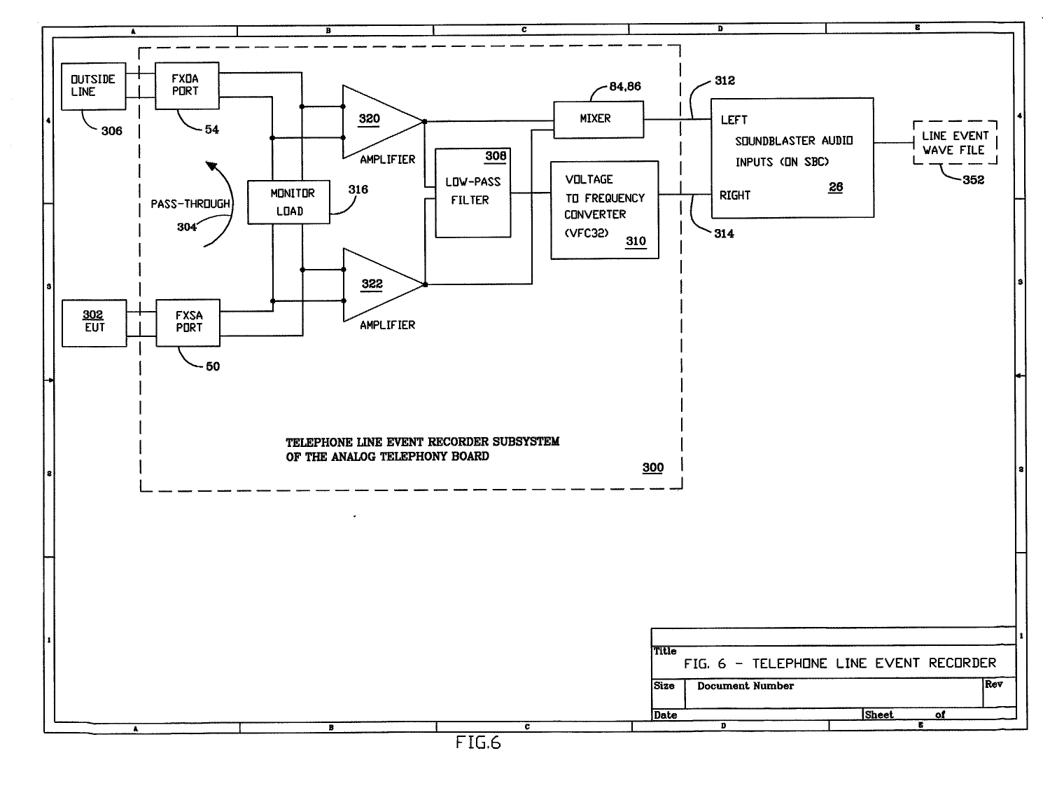

FIG. 6 shows a block diagram of an embodiment of the telephone line event recorder 300. In order to record a telephone line event, the telephone line is connected to the FXOA port 54. The equipment under test (EUT) 302 is connected to the FXSA port 50 and the tester is switched to the PASS mode, which enables a pass-though connection 304 between the EUT 302 and the line 306 that is connected to the FXOA port 54. The telephone event monitor system 316 allows the tester to monitor both AC and DC line conditions. The EUT 302 is configured to initiate a call sequence, or in the case of an incoming call, it is configured to receive a call. A button of the front panel is pressed to start the recording. The AC signal at the EUT terminal 302 is amplified and recorded on the left channel 312 of the SoundBlaster audio subsystem 26 on the SBC 12. These signals are in the audio frequency range and within normal telephony dynamic range of +10 dBm to −48 dBm. The telephone line DC voltage or the DC line current conditions may also be monitored by the system.

To record line voltage, the DC voltage across from the EUT 302 is low-pass filtered 308, and converted to a voice-band frequency using a voltage to frequency converter 310, such as the Burr-Brown VFC32 IC. The output of the voltage to frequency converter 310 is recorded on the right channel 314 of the SoundBlaster subsystem 26 at the same time the AC is recorded on the left channel 312. To record line current, the differential voltage across a dummy load in series between the FXOA port 54 and EUT 302 is recorded using the same technique used for line voltage. At the end of the test event, the button on the front panel is pressed to end recording. The recording session may also be performed under local or remote software control.

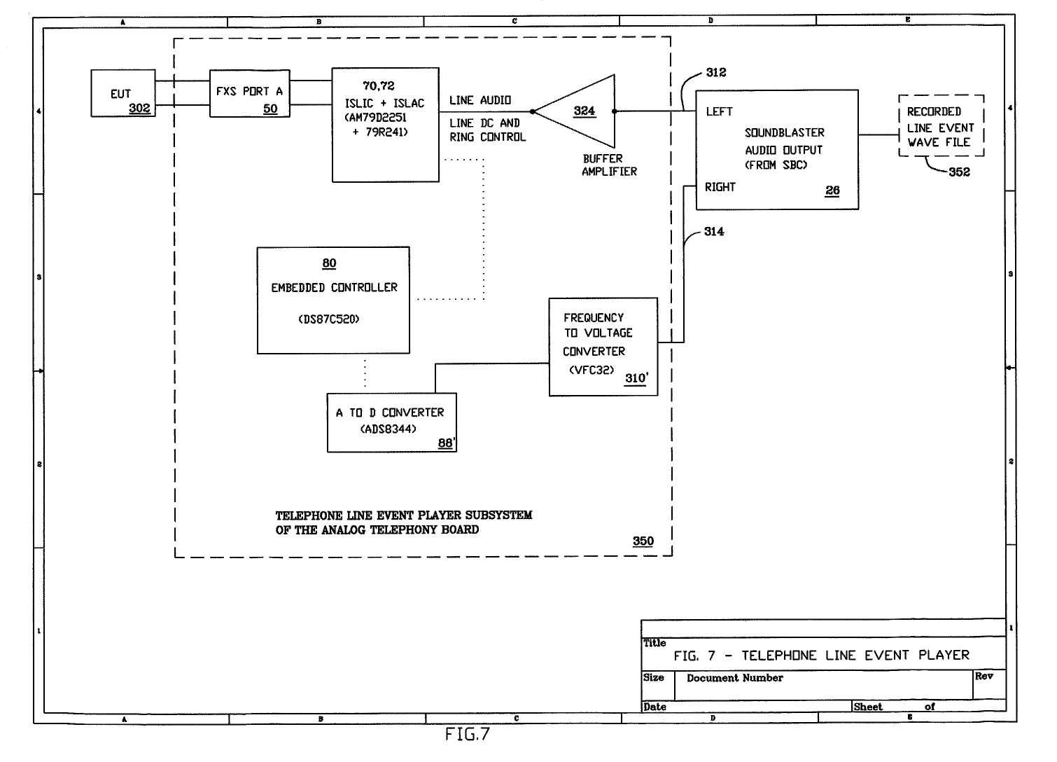

FIG. 7 shows a block diagram of an embodiment of the telephone line event player 350. The play process is essentially the reverse of the line event recording process. It uses the tester's ability to simulate a telephone line to approximate the conditions that have been recorded. In order to play back the recorded event, the external line 306 is normally disconnected from the FXOA port 54 and the tester switched to its normal feed mode. The pass-though switch 304, which was used during recording phase, is disconnected. The preferred embodiment features two software-programmable FXS ports 50 and 52 on the analog telephony board 16. The FXS circuit 50 and 52 allows line DC voltage, ringing and AC conditions to be varied independently. In order to play back the recorded audio, the corresponding SoundBlaster wave file 352 is played back and the audio signal is gain-controlled and coupled to the ISLIC 72 for reproduction across the FXSA 50 port.

In order to reproduce the DC line voltage, the audio signal on the right channel 314 of the SoundBlaster wave file 352 is converted to a voltage using a frequency to voltage converter IC 310', such as the Burr-Brown VFC32. The output voltage from the frequency to voltage converter is used to provide a controlled-current feed to the ISLIC 72 which, in turn, replicates the recorded DC line voltage conditions.

To reproduce a line current condition, which was recorded using a dummy load, the current is calculated by the embedded microcontroller to be equal to the measured voltage divided by the resistance of the dummy load. The ISLIC 72 is then programmed to provide the desired current.

The telephone line event recorder and player 96 of the invention provide a new way for test engineers to replicate and troubleshoot field problems in a laboratory environment. Telecommunication equipment, which operates correctly in a test environment, may fail under real-life conditions that have not been taken into consideration. By capturing the DC and AC conditions of the line with this system, it is possible to faithfully reproduce these conditions at distant locations. By recording the conditions, it is also possible to observe, measure, and analyze transient or intermittent conditions that may not occur at the time that a technician is available to test the system in real time.

One embodiment incorporates two communication ports A and B. Port A can be an FXS 50, FXO 54, E&M 58 (PBX-side), handset port 62, a channel on an external T1/E1/J1 digital trunk, a voice-band channel on an expansion PCM trunk, the SBC's 12 SoundBlaster's 26 record/playback channels, or an Ethernet-based voice-band channel. Port B can be an FXS 52, FXO 56, E&M 60 (trunk-side), a channel on an external T1/E1/J1 digital trunk, a voice-band channel on an expansion PCM trunk, the SBC's 12 record/playback channels, an external audio in/out port, or an Ethernet-based voice-band channel. A connection can be made from port A to port B or vice-versa. The embodiment also features a non-intrusive measurement subsystem, which can be used to measure the AC and DC parameters on either port A or port B. The embodiment also features a recording subsystem, which can be used to record audio on port A, port B, or port A on one of the stereo channels and port B on the other channel. The embodiment can also simultaneously record and play back audio wave files. This makes it possible to play a wave file on port A and record the audio present on port B, and vice-versa. The full-duplex capability of the SoundBlaster subsystem 26 in the SBC 12 makes this possible. The embodiment features DTMF tone generation and detection on port A and port B. It is also capable of detecting DTMF while in a high-impedance monitoring mode.

This invention has particular relevance for engineers and technicians, who wish to perform tests and measurements on telephone lines and apparatus. In one embodiment, which is based on the x86 architecture, the system can run tests that have already been developed for PC's with a minimum of adaptation. For example, PSQM tests based on the P.861 are available for licensing from a number of companies.

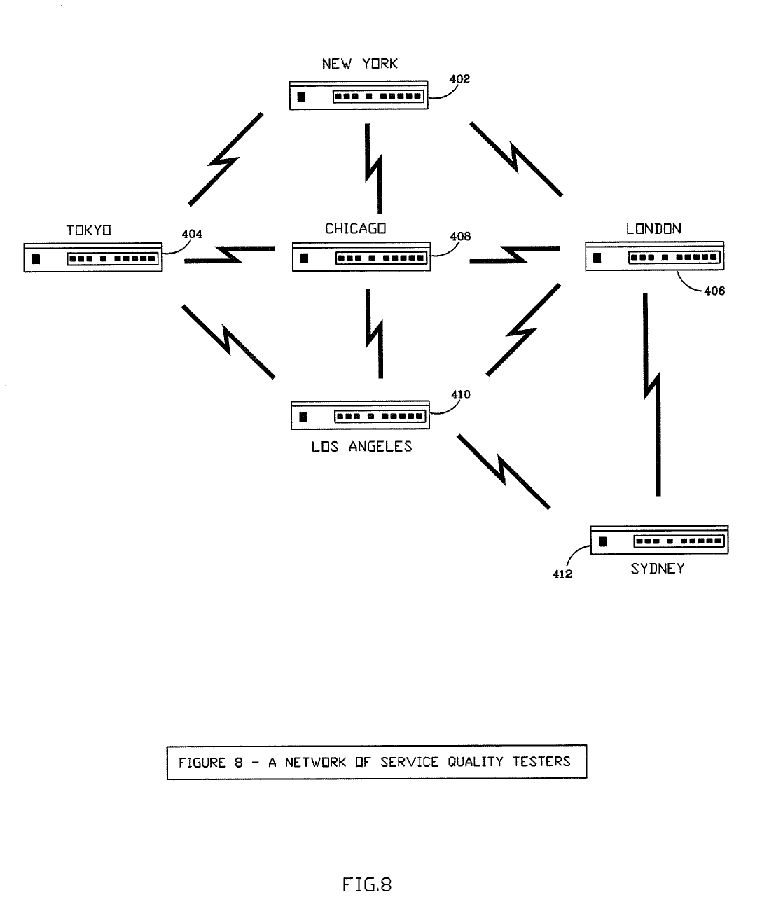

The system can be programmed for unattended and remote applications. The invention contemplates the installation of a number of the testers across VON nodes, and at selected PSTN locations around the world. Such a network can provide remote service quality measurements, telephony signaling monitoring and measurements, and alternative service provisioning decision support. Each system can be configured and updated with new operating software, through the use of telnet and other remote Internet control utilities. FIG. 8 shows an exemplary network 400 of testers 402, 404, 406, 408, 410, and 412 located at six major cities.

One application of an embodiment of this invention is to provide a quality of service measurement support to VON subscribers who have a choice between several service providers. The system features a SBC 12 that can be programmed to perform call routing decision in different ways. In one embodiment, the tester can be used to perform a P.861 PSQM measurement for a given destination before actually placing the call. The tester can place a short 3 to 6 second test call to the desired location over the preferred carrier and measure the PSQM. If the quality is acceptable, e.g., an observed PSQM score is greater than 3.5, the router is instructed to proceed with routing the call over that carrier. If the quality is not acceptable, another test call is placed over an alternative carrier. If the quality is better, the alternative carrier is selected. If not, the router may be instructed to route the call over a traditional PSTN network, as the quality that is possible between the available VON carriers is not good enough. Other factors may also be used to select a carrier, such as cost and packet delays.

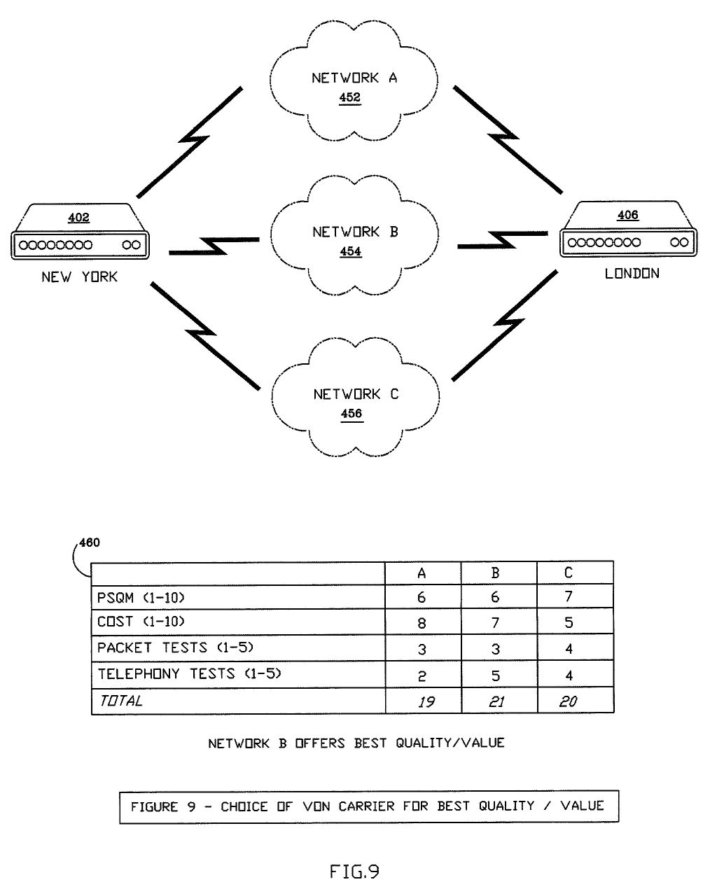

FIG. 9 shows an exemplary method of making a selection based on three available VON networks 452, 454 and 456. In FIG. 9, there is shown an exemplary table of results 460 that are measured for each of the three networks. Each network, designated A 452, B 454 and C 456, which are shown as network connections between New York and London, is tested. The parameters examined in the exemplary test are PSQM, cost, packet tests and telephony tests. A range of possible grades is listed in parenthesis beside the name of each test parameter. In the exemplary table, a higher score is better than a lower score for each test parameter. For example, a lower cost can be assigned a higher score, and a better quality of telephony performance can be assigned a higher score. The network scoring the highest cumulative score, namely Network B 454 with a total score of 21, is selected as the best choice.

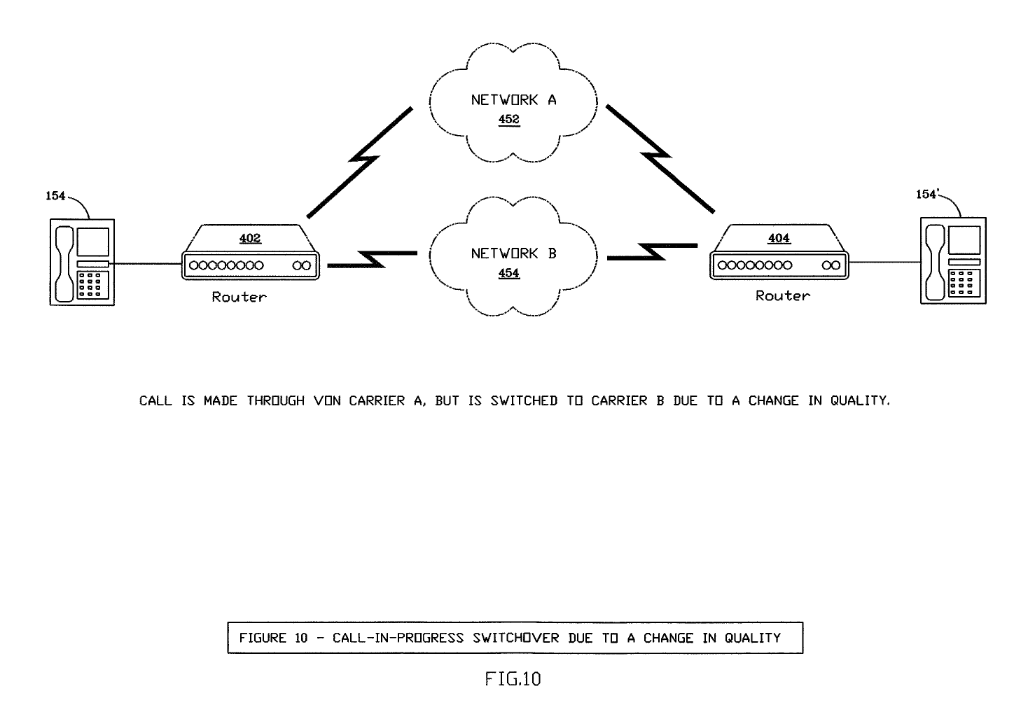

It is known that quality of VON voice connections is not always consistent. Some calls, which start satisfactorily, may later be degraded due to network congestion and delays. The invention provides methods and systems for enabling users to improve the quality of their VON calls by switching a call to another VON carrier. In one embodiment, the user presses one or more DTMF keys once the quality starts to degrade and a different carrier becomes necessary. The system, which can perform a non-intrusive monitoring of signals on the line, detects the DTMF tones and performs short test calls over other VON networks. If a better quality service provider is found, the system requests a call switchover from the alternative VON carrier and provides the alternative VON with a unique call-in-progress header and the destination information. The system changes the routing information on the speech packets to the telephony server of the alternative carrier. If the router is capable of processing the switchover by itself, the system only gives it the new carrier routing information and the unique call-in-progress header. This system and method is depicted in FIG. 10.

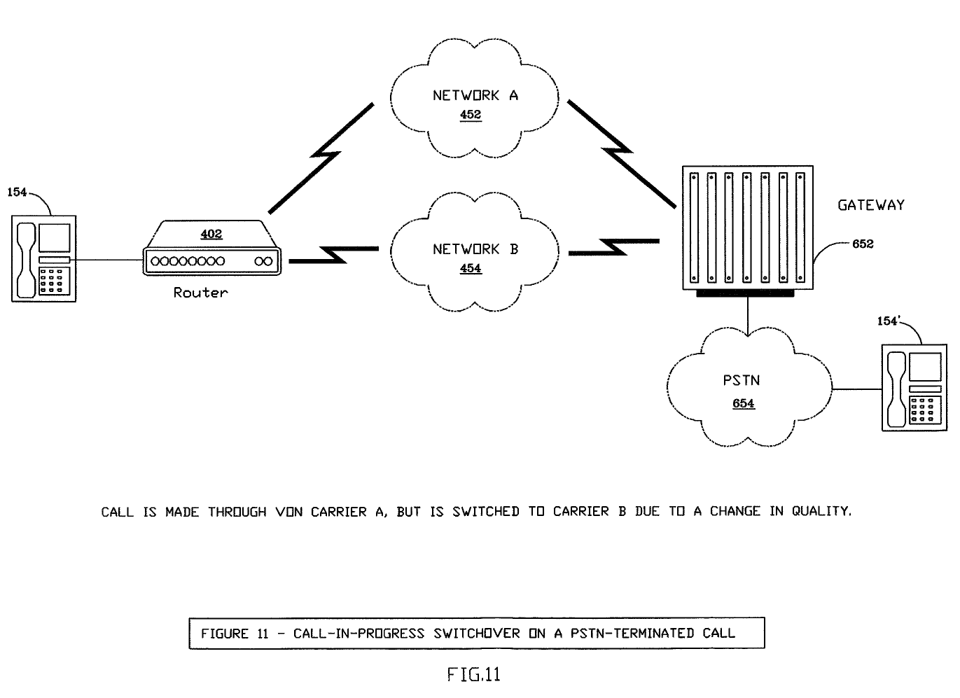

In some cases, a gateway is used, and it is not possible to interrupt the connection between one of the parties and a PSTN. In one embodiment, a novel method and system provides the switchover using the conference call feature that is supported by many gateways as a part of the multipoint control unit component of the H.323 standard, or its equivalent for other protocols. In one embodiment, a conference call is established with a call placed over an alternative carrier, and immediately after the connection is made, the original call is terminated. This system and method for switching a call to a different network is depicted schematically in FIG. 11.

In an application of one embodiment of the invention, the system can make use of speech recognition technology to detect problems on VON calls in progress. The system can monitor the voice calls for such words as “hello . . . hello,” “speak up,” “I can't hear you,” or long pauses, echoes, or static noise, that indicate possible problems with the quality of the connection when equipped with a speaker-independent speech recognition software running on the SBC 12 or the DSP 112. Problems associated with the quality of the connection, for example problems such as those enumerated above, may prompt the system to search for an alternative service provider and, if one is found, initiate a switch to it without interrupting the call in progress.

Although the invention has been described in detail, those skilled in the art should understand that they can make various changes, substitutions, and alterations herein without departing from the spirit and scope of the invention in its broadest form.

While the invention has been particularly shown and described with reference to specific embodiments, it should be understood by those skilled in the art that various changes in form and detail may be made therein without departing from the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. An analyzer system for tracking quality of voice services over a telephony network, said analyzer system connected to at least one node of at least one telephony network, said analyzer system comprising:
a connector adapted for a non-intrusive, high-impedance interface to said telephony network;
a high-impedance measurement subsystem capable of measuring quality of voice services passing through each said node on each said telephony network;
a quality of service analysis subsystem that analyzes quality of service for each said telephony network for a plurality of calls made over said telephony network through said node; and
a data store that records the analysis of the quality of service analysis subsystem.

2. The analyzer system of claim 1, further comprising a recording system for recording telephony communications.

3. The analyzer system of claim 1, further comprising a reporting subsystem that sends one or more said analyses of the quality of service analysis subsystem to a predetermined destination via the telephony network.

4. The analyzer system of claim 1, further comprising:
a monitoring subsystem that analyzes said recorded analyses and ascertains whether said quality of service falls below a predefined level; and
a notification subsystem whereby said analyzer system sends a message via the telephony network to a predefined destination when said quality of service falls below a predefined level.

5. An analyzer system for tracking quality of voice services over a telephony network and connected to at least two nodes corresponding to at least one telephony network, said analyzer system comprising:
at least one high-impedance measurement subsystem capable of measuring quality of service of each said telephony network by analyzing a voice communication passing through each said node on each said telephony network;
at least one quality of service analysis subsystem that analyzes quality of service for at least one of said telephony networks for the duration of at least one call made over said telephony networks and passing through said corresponding nodes connected to said telephony networks;

6. An analyzer system for tracking quality of voice services over a telephony network and connected to at least two nodes corresponding to at least one telephony network, said analyzer system comprising:
at least one additional telephony network; and
at least one switching subsystem corresponding to each quality of service analysis subsystem that, if during the course of a call said quality of service analysis subsystem detects a degradation of said quality of service on a first telephony network, said switching subsystem immediately switches the call to a second telephony network for uninterrupted servicing of said call.

7. The analyzer system of claim 5, further comprising at least one circuit-switched network wherein said analyzer system is connected to at least one node corresponding to said circuit-switched network and wherein said switching subsystem can select said circuit-switched network in lieu of said telephony networks and thereby switch said call to said circuit-switched network for uninterrupted servicing of said call.

8. A system for comparing quality of voice services in a plurality of telephony networks, said system comprising:
at least two telephony networks;
at least two analyzer systems wherein each such analyzer system is connected to a node on at least two of said telephony networks, each such analyzer system comprising a system capable of measuring quality of voice services over a telephony network;
at least one testing subsystem corresponding to one said analyzer system by which such analyzer system initiates at least two calls over at least two of said telephony networks to at least one other analyzer system and analyzes the quality of voice services between said first analyzer system and said second analyzer system over said telephony networks over which said calls were made;
at least one selection subsystem corresponding to each testing subsystem by which said corresponding analyzer system can select one telephony network from among the plurality of telephony networks tested for routing at least one call through said node corresponding to said corresponding analyzer system to another node, said selection based at least in part on an evaluation of said analyses by said corresponding testing subsystem.

9. The system of claim 8, wherein said system is a personal computer system comprising hardware and software components.

10. The analyzer system of claim 8, further comprising an circuit-switched network and wherein each said selection subsystem can select said circuit-switched network over the plurality of telephony networks for routing at least one call through said node corresponding to said corresponding analyzer system to another node, said selection based at least in part on an evaluation of said analyses by said corresponding testing subsystem.

11. A system for comparing quality of voice services in a plurality of telephony networks, said system comprising:
a first telephony network;
a second telephony network;
a first analyzer system connected to both a first node on said first telephony network and to a first node on said second telephony network, said first analyzer system comprising a system capable of measuring quality of voice services over a telephony network;
a second analyzer system connected to both a second node on said first telephony network and to a second node on said second telephony network, said second analyzer system comprising a system capable of measuring quality of voice services over a telephony network;
a first testing subsystem by which said first analyzer system initiates a first call over said first telephony network to said second analyzer system and analyzes the quality of voice services between said first analyzer system and said second analyzer system over said first telephony network, and by which said first analyzer system initiates a second call over said second telephony network to said second analyzer system and analyzes the quality of voice services between said first analyzer system and said second analyzer system over said second telephony network;
a first selection subsystem by which said first analyzer system selects one such telephony network for at least one call routed through said first node to said second node, said selection based at least in part on an evaluation of said analyses by said first testing subsystem.

12. The system of claim 11, wherein said system is a personal computer system comprising hardware and software components.

13. The system of claim 11, further comprising:
a second testing subsystem by which said second analyzer system, upon receipt of said first call from said first analyzer system, analyzes the quality of voice services between said first analyzer system and said second analyzer system over said first telephony network, and by which said second analyzer system, upon receipt of said second call from said first analyzer system, analyzes the quality of voice services between said first analyzer system and said second analyzer system over said second telephony network;
a second selection subsystem by which said second analyzer system selects one such telephony network for a call routed through said second node to said first node, said selection based at least in part on an evaluation of said analyses by said second testing subsystem.

14. The system of claim 11, further comprising at least one additional analyzer system, each such additional analyzer system connected to an additional node on said first telephony network and to an additional node on said second telephony network, each such additional analyzer system comprising a system capable of measuring quality of voice services over a telephony network, and wherein said first testing subsystem of said first analyzer system initiates a first call over said first telephony network to each said additional analyzer system and analyzes the quality of voice services between said first analyzer system and each said additional analyzer system over said first telephony network, and wherein said first analyzer system initiates a second call over said second telephony network to each said additional analyzer system and analyzes the quality of voice services between said first analyzer system and each said additional analyzer system over said second telephony network, and wherein said first selection subsystem of said first analyzer system selects one such telephony network from among those analyzed for at least one call routed through said first node to said second node and for at least one call routed to each of said additional nodes, each said selection based at least in part on an evaluation of said analyses by said first testing subsystem.

15. The system of claim 14, further comprising:
at least one additional testing subsystem by which at least one of said additional analyzer systems, upon receipt of said first call from said first analyzer system, analyzes the quality of voice services between said first analyzer and such said additional analyzer system over said first telephony network, and by which said second analyzer system, upon receipt of said second call from said first analyzer system, analyzes the quality of voice services between said first analyzer system and such said additional analyzer system over said second telephony network;
at least one additional selection subsystem corresponding to each said additional testing subsystem whereby each such said additional selection subsystem selects one such telephony network for a call routed through each such said additional node to said first node, said selection by each such said additional selection subsystem based at least in part on an evaluation of said analyses by each said additional testing subsystem.

16. The system of claim 11, further comprising at least one additional telephony network wherein said first analyzer system is connected to a first node on said each additional telephony network, wherein said second analyzer system is connected to a second node on said each additional telephony network, wherein said first testing subsystem by which said first analyzer system initiates an additional call over said each additional telephony network to said second analyzer system and analyzes the quality of voice services between said first analyzer system and said second analyzer system over said each additional telephony network, and wherein said first selection subsystem selects a telephony network from a group of networks—said group of networks comprising said first telephony network, said second telephony networks, and said each additional telephony network—for at least one call routed through said first node to said second node, said selection based at least in part on an evaluation of said analyses by said first testing subsystem.

17. The system of claim 16 further comprising:
a second testing subsystem by which said second analyzer system, upon receipt of said first call from said first analyzer system, analyzes the quality of voice services between said first analyzer and said second analyzer over said first telephony network, and by which said second analyzer system, upon receipt of said second call from said first analyzer system, analyzes the quality of voice services between said first analyzer and said second analyzer over said second telephony network, and by which said second analyzer system, upon receipt of said each additional call from said first analyzer system, analyzes the quality of voice services between said first analyzer and said second analyzer over said each additional telephony network.
a second selection subsystem by which said second analyzer system selects a telephony network from a group of networks—said group of networks comprising said first telephony network, said second telephony networks, and said each additional telephony network—for at least one call routed through said first node to said second node, said selection based at least in part on an evaluation of said analyses by said first testing subsystem.

18. The system of claim 16, further comprising at least one additional analyzer system, each such additional analyzer system connected to an additional node on said first telephony network and to an additional node on said second telephony network and an additional node on each additional telephony network, each such additional analyzer system comprising a system capable of measuring quality of voice services over a telephony network, and wherein said first testing subsystem of said first analyzer system initiates a first call over said first telephony network to each said additional analyzer system and analyzes the quality of voice services between said first analyzer system and each said additional analyzer system over said first telephony network, and wherein said first analyzer system initiates a second call over said second telephony network to each said additional analyzer system and analyzes the quality of voice services between said first analyzer system and each said additional analyzer system over said second telephony network, and wherein said first analyzer system initiates an additional call over each said additional telephony network to each said additional analyzer system and analyzes the quality of voice services between said first analyzer system and each said additional analyzer system over each said additional telephony network, and wherein said first selection subsystem of said first analyzer system selects, for each node tested, at least one such telephony network for each node from among those analyzed for at least one call routed through said first node to each of said additional nodes, each said selection based at least in part on an evaluation of said analyses by said first testing subsystem.

19. The system of claim 18, wherein said system is a personal computer system comprising hardware and software components.

20. The system of claim 16, wherein at least one of said additional telephony networks is a hybrid VON/PSTN network.

21. The system of claim 11, wherein at least one of said telephony networks is a hybrid VON/PSTN network.

22. A system for comparing quality of voice services in a plurality of telephony networks, said system comprising:
a first telephony network;
a second telephony network;
a first analyzer system connected to both a first node on said first telephony network and to a first node on said second telephony network, said first analyzer system comprising a system capable of measuring quality of voice services over a telephony network;
a second analyzer system connected to both a second node on said first telephony network and to a second node on said second telephony network, said second analyzer system comprising a system capable of measuring quality of voice services over a telephony network;
a first testing subsystem by which both said first analyzer system initiates a first call over said first telephony network to said second analyzer system and analyzes the quality of voice services between said first analyzer system and said second analyzer system over said first telephony network, and by which said first analyzer system, upon receipt of a second call from said second analyzer system, analyzes the quality of voice services between said first analyzer system and said second analyzer system over said second telephony network;
a second testing subsystem by which both said second analyzer system, upon receipt of said first call from said first analyzer system, analyzes the quality of voice services between said first analyzer system and said second analyzer system over said first telephony network, and by which said second analyzer system initiates a second call over said second telephony network to said first analyzer system and analyzes the quality of voice services between said first analyzer system and said second analyzer system over said second telephony network;
a first selection subsystem by which said first analyzer system selects at least one such telephony network for calls routed through said first node to said second node, said selection based at least in part on an evaluation of said analyses by said first testing subsystem; and
a second selection subsystem by which said second analyzer system selects at least one such telephony network for at least one call routed through said second node to said first node, said selection based at least in part on an evaluation of said analyses by said second testing subsystem.

23. The system of claim 22, wherein said system is a personal computer system comprising hardware and software components.

24. The system of claim 22, wherein at least one of said telephony networks is a hybrid VON/PSTN network.

25. A system for comparing quality of voice services on modem telephony networks, including VON, PSTN, and hybrid VON/PSTN networks, to an circuit-switched network such as PSTN, said system comprising:
a first telephony network;
a first circuit-switched network;
a first analyzer system connected to a first node on said first telephony network, said first analyzer system comprising a system capable of measuring quality of voice services over a telephony network;
a second analyzer system connected to a second node on said first telephony network, said second analyzer system comprising a system capable of measuring quality of voice services over a telephony network;
a first testing subsystem by which said first analyzer system initiates a first call over said first telephony network to said second analyzer system and analyzes the quality of voice services between said first analyzer system and said second analyzer system over said first telephony network;
a first selection subsystem by which said first analyzer system selects at least one such network for at least one call routed through said first node to said second node, said selection based at least in part on an evaluation of said analysis by said first testing subsystem.

26. The system of claim 25, wherein said system is a personal computer system comprising hardware and software components.

27. The system of claim 25, further comprising:
a second testing subsystem by which said second analyzer system, upon receipt of said first call from said first analyzer system, analyzes the quality of voice services between said first analyzer and said second analyzer over said first telephony network; and
a second selection subsystem by which said second analyzer system selects at least one such network for a call routed through said second node to said first node, said selection based at least in part on an evaluation of said analysis by said second testing subsystem.

28. The system of claim 25, wherein said telephony network is a hybrid VON/PSTN network.

29. A system for comparing quality of voice services provided by a plurality of telephony service-providers, said system comprising:
at least two telephony service-providers;
at least two analyzer systems wherein each such analyzer system is connected to a node on a network for least two of said telephony service-providers, each such analyzer system comprising a system capable of measuring quality of voice services over a telephony service-provider network;
at least one testing subsystem corresponding to one said analyzer system by which such analyzer system initiates at least two calls through at least two of said telephony service-providers to at least one other analyzer system and analyzes the quality of voice services between said first analyzer system and said second analyzer system through said telephony service-providers with which said calls were made;
at least one selection subsystem corresponding to each testing subsystem by which said corresponding analyzer system can select one telephony service-provider from among the plurality of telephony service-providers tested for routing at least one call through said node corresponding to said corresponding analyzer system to another node, said selection based at least in part on an evaluation of said analyses by said corresponding testing subsystem.

30. The system of claim 8, wherein said system is a personal computer system comprising hardware and software components.

31. The analyzer system of claim 8, further comprising an circuit-switched service-provider and wherein each said selection subsystem can select said circuit-switched service-provider in lieu of the plurality of telephony service-providers for routing at least one call through said node corresponding to said corresponding analyzer system to another node, said selection based at least in part on an evaluation of said analyses by said corresponding testing subsystem.

32. A system for comparing quality of voice services in a plurality of telephony service-providers, said system comprising:
a first telephony service-provider;
a second telephony service-provider;
a first analyzer system connected to both a first node on a network of said first telephony service-provider and to a first node on a network of said second telephony service-provider, said first analyzer system comprising a system capable of measuring quality of voice services over a telephony service-provider network;
a second analyzer system connected to both a second node on a network of said first telephony service-provider and to a second node on a network of said second telephony service-provider, said second analyzer system comprising a system capable of measuring quality of voice services over a telephony service-provider network;
a first testing subsystem by which said first analyzer system initiates a first call through said first telephony service-provider to said second analyzer system and analyzes the quality of voice services between said first analyzer system and said second analyzer system over said first telephony service-provider, and by which said first analyzer system initiates a second call through said second telephony service-provider to said second analyzer system and analyzes the quality of voice services between said first analyzer system and said second analyzer system over said second telephony service-provider;
a first selection subsystem by which said first analyzer system selects one such telephony service-provider for at least one call routed through said first node to said second node, said selection based at least in part on an evaluation of said analyses by said first testing subsystem.

33. The system of claim 11, wherein said system is a personal computer system comprising hardware and software components.

34. The system of claim 11, further comprising:
a second testing subsystem by which said second analyzer system, upon receipt of said first call from said first analyzer system, analyzes the quality of voice services between said first analyzer system and said second analyzer system through said first telephony service-provider, and by which said second analyzer system, upon receipt of said second call from said first analyzer system, analyzes the quality of voice services between said first analyzer system and said second analyzer system through said second telephony service-provider;
a second selection subsystem by which said second analyzer system selects one such telephony service-provider for a call routed through said second node to said first node, said selection based at least in part on an evaluation of said analyses by said second testing subsystem.

35. The system of claim 11, further comprising at least one additional analyzer system, each such additional analyzer system connected to an additional node on a network of said first telephony service-provider and to an additional node on a network of said second telephony service-provider, each such additional analyzer system comprising a system capable of measuring quality of voice services through a telephony service-provider, and wherein said first testing subsystem of said first analyzer system initiates a first call through said first telephony service-provider to each said additional analyzer system and analyzes the quality of voice services between said first analyzer system and each said additional analyzer system through said first telephony service-provider, and wherein said first analyzer system initiates a second call through said second telephony service-provider to each said additional analyzer system and analyzes the quality of voice services between said first analyzer system and each said additional analyzer system through said second telephony service-provider, and wherein said first selection subsystem of said first analyzer system selects one such telephony service-provider from among those analyzed for at least one call routed through said first node to said second node and for at least one call routed to each of said additional nodes, each said selection based at least in part on an evaluation of said analyses by said first testing subsystem.

36. The system of claim 14, further comprising:
at least one additional testing subsystem by which at least one of said additional analyzer systems, upon receipt of said first call from said first analyzer system, analyzes the quality of voice services between said first analyzer and such said additional analyzer system through said first telephony service-provider, and by which said second analyzer system, upon receipt of said second call from said first analyzer system, analyzes the quality of voice services between said first analyzer system and such said additional analyzer system through said second telephony service-provider;
at least one additional selection subsystem corresponding to each said additional testing subsystem whereby each such said additional selection subsystem selects one such telephony service-provider for a call routed through each such said additional node to said first node, said selection by each such said additional selection subsystem based at least in part on an evaluation of said analyses by each said additional testing subsystem.

37. The system of claim 11, further comprising at least one additional telephony service-provider wherein said first analyzer system is connected to a first node on said each additional telephony service-provider, wherein said second analyzer system is connected to a second node on said each additional telephony service-provider, wherein said first testing subsystem by which said first analyzer system initiates an additional call through said each additional telephony service-provider to said second analyzer system and analyzes the quality of voice services between said first analyzer system and said second analyzer system through said each additional telephony service-provider, and wherein said first selection subsystem selects a telephony service-provider from a group of service-providers—said group of service-providers comprising said first telephony service-provider, said second telephony service-providers, and said each additional telephony service-provider—for at least one call routed through said first node to said second node, said selection based at least in part on an evaluation of said analyses by said first testing subsystem.

38. The system of claim 16 further comprising:
a second testing subsystem by which said second analyzer system, upon receipt of said first call from said first analyzer system, analyzes the quality of voice services between said first analyzer and said second analyzer through said first telephony service-provider, and by which said second analyzer system, upon receipt of said second call from said first analyzer system, analyzes the quality of voice services between said first analyzer and said second analyzer through said second telephony service-provider, and by which said second analyzer system, upon receipt of said each additional call from said first analyzer system, analyzes the quality of voice services between said first analyzer and said second analyzer through said each additional telephony service-provider.
a second selection subsystem by which said second analyzer system selects a telephony service-provider from a group of service-providers—said group of service-providers comprising said first telephony service-provider, said second telephony service-providers, and said each additional telephony service-provider—for at least one call routed through said first node to said second node, said selection based at least in part on an evaluation of said analyses by said first testing subsystem.

39. The system of claim 16, further comprising at least one additional analyzer system, each such additional analyzer system connected to an additional node on said first telephony service-provider and to an additional node on said second telephony service-provider and an additional node on each additional telephony service-provider, each such additional analyzer system comprising a system capable of measuring quality of voice services through a telephony service-provider, and wherein said first testing subsystem of said first analyzer system initiates a first call through said first telephony service-provider to each said additional analyzer system and analyzes the quality of voice services between said first analyzer system and each said additional analyzer system through said first telephony service-provider, and wherein said first analyzer system initiates a second call through said second telephony service-provider to each said additional analyzer system and analyzes the quality of voice services between said first analyzer system and each said additional analyzer system through said second telephony service-provider, and wherein said first analyzer system initiates an additional call through each said additional telephony service-provider to each said additional analyzer system and analyzes the quality of voice services between said first analyzer system and each said additional analyzer system through each said additional telephony service-provider, and wherein said first selection subsystem of said first analyzer system selects, for each node tested, at least one such telephony service-provider for each node from among those analyzed for at least one call routed through said first node to each of said additional nodes, each said selection based at least in part on an evaluation of said analyses by said first testing subsystem.

40. The system of claim 18, wherein said system is a personal computer system comprising hardware and software components.

41. The system of claim 16, wherein at least one of said additional telephony service-providers is a hybrid VON/PSTN service-provider.

42. The system of claim 11, wherein at least one of said telephony service-providers is a hybrid VON/PSTN service-provider.

43. A system for comparing quality of voice services in a plurality of telephony service-providers, said system comprising:
a first telephony service-provider;
a second telephony service-provider;
a first analyzer system connected to both a first node on a network of said first telephony service-provider and to a first node on said second telephony service-provider, said first analyzer system comprising a system capable of measuring quality of voice services through a telephony service-provider;
a second analyzer system connected to both a second node on a network of said first telephony service-provider and to a second node on said second telephony service-provider, said second analyzer system comprising a system capable of measuring quality of voice services through a telephony service-provider;
a first testing subsystem by which both said first analyzer system initiates a first call through said first telephony service-provider to said second analyzer system and analyzes the quality of voice services between said first analyzer system and said second analyzer system through said first telephony service-provider, and by which said first analyzer system, upon receipt of a second call from said second analyzer system, analyzes the quality of voice services between said first analyzer system and said second analyzer system through said second telephony service-provider;
a second testing subsystem by which both said second analyzer system, upon receipt of said first call from said first analyzer system, analyzes the quality of voice services between said first analyzer system and said second analyzer system through said first telephony service-provider, and by which said second analyzer system initiates a second call through said second telephony service-provider to said first analyzer system and analyzes the quality of voice services between said first analyzer system and said second analyzer system through said second telephony service-provider;
a first selection subsystem by which said first analyzer system selects at least one such telephony service-provider for calls routed through said first node to said second node, said selection based at least in part on an evaluation of said analyses by said first testing subsystem; and
a second selection subsystem by which said second analyzer system selects at least one such telephony service-provider for at least one call routed through said second node to said first node, said selection based at least in part on an evaluation of said analyses by said second testing subsystem.

44. The system of claim 22, wherein said system is a personal computer system comprising hardware and software components.

45. The system of claim 22, wherein at least one of said telephony service-providers is a hybrid VON/PSTN service-provider.

46. A system for comparing quality of voice services on modern telephony service-providers, including VON, PSTN, and hybrid VON/PSTN service-providers, to an circuit-switched service-provider such as PSTN, said system comprising:
a first telephony service-provider;
a first circuit-switched service-provider;
a first analyzer system connected to a first node on a network of said first telephony service-provider, said first analyzer system comprising a system capable of measuring quality of voice services through a telephony service-provider;
a second analyzer system connected to a second node on a network of said first telephony service-provider, said second analyzer system comprising a system capable of measuring quality of voice services through a telephony service-provider;
a first testing subsystem by which said first analyzer system initiates a first call through said first telephony service-provider to said second analyzer system and analyzes the quality of voice services between said first analyzer system and said second analyzer system through said first telephony service-provider;
a first selection subsystem by which said first analyzer system selects at least one such service-provider for at least one call routed through said first node to said second node, said selection based at least in part on an evaluation of said analysis by said first testing subsystem.

47. The system of claim 25, wherein said system is a personal computer system comprising hardware and software components.

48. The system of claim 25, further comprising:
a second testing subsystem by which said second analyzer system, upon receipt of said first call from said first analyzer system, analyzes the quality of voice services between said first analyzer and said second analyzer through said first telephony service-provider; and
a second selection subsystem by which said second analyzer system selects at least one such service-provider for a call routed through said second node to said first node, said selection based at least in part on an evaluation of said analysis by said second testing subsystem.

49. The system of claim 25, wherein said telephony service-provider is a hybrid VON/PSTN service-provider.

50. A system for measuring quality of voice services on modern telephony networks, including VON, PSTN, and hybrid VON/PSTN networks, said system comprising an analyzer that measures quality of service of a signal transmitted over the telephony network.

51. The system of claim 50, further comprising a connector adapted to make a connection to said test point in the telephony network.

52. The system of claim 50, wherein said analyzer comprises a computer system.

53. The system of claim 52, wherein said computer system is a personal computer system comprising hardware and software components.

54. The system of claim 52, wherein said analyzer further comprises a configuration subsystem that configures said computer system to interface with said telephony network.

55. The system of claim 50, wherein said analyzer further comprises a quality of service analysis subsystem that performs an analysis of said quality of service of said signal.

56. The system of claim 55, wherein said analyzer further comprises a report generator that reports a result of said analysis of said quality of service of said signal.

57. The system of claim 50, wherein said analyzer further comprises a communications protocol analysis subsystem that performs an analysis of adherence to said communication protocol.

58. The system of claim 57, wherein said analyzer further comprises a report generator that reports a result of said analysis of adherence to said communication protocol.

59. The system of claim 50, wherein said analyzer further comprises:
a quality of service analysis subsystem that performs an analysis of said quality of service of said signal; and
a communications protocol analysis subsystem that performs an analysis of adherence to said communication protocol.

60. The system of claim 59, wherein said analyzer further comprises a report generator that reports both a result of said analysis of said quality of service of said signal and said analysis of adherence to said communication protocol.

61. The system of claim 51, wherein said analyzer comprises:
a computer system;
a configuration subsystem that configures said computer system to interface with said telephony network;
a quality of service analysis subsystem that performs an analysis of said quality of service of said signal; and
a report generator that reports both a result of said analysis of said quality of service of said signal and said analysis of adherence to said communication protocol.

62. The system of claim 61, wherein said system is a personal computer system comprising hardware and software components.

63. The system of claim 61, wherein said connector is a handset connector that couples to a telephone handset to make said connection.

64. The system of claim 61, wherein said connector is a base connector that couples to a telephone base to make said connection.

65. The system of claim 61, further comprising a recorder that records signals transmitted by the telephony network at said test point.

66. The system of claim 65, further comprising a reproduction unit that reproduces the recorded signal through the telephony network at said test point to permit a determination of a speech quality.

67. The system of claim 61, wherein said quality of service analysis subsystem comprises a subsystem that tests quality of service selected from a figure of merit for voice clarity, a figure of merit for voice intelligibility, a voice level, a power, a timing signal, or a delay.

68. The system of claim 61, wherein said quality of service analysis subsystem comprises a subsystem that tests a telephony condition selected from an AC call-control signal, a DC call-control signal, a call progress tone, or a CLASS signal.

69. The system of claim 61, wherein said connector comprises a connector adapted to connect to a selected one of a telephone handset, a telephone base unit, a line card, an FXS port, and FXO port, an E&M port, a T1/E1/J1 digital trunk, an Ethernet port, audio in and out ports, or a router.

70. The system of claim 61, further comprising a comparison subsystem that compares results obtained from tests performed between two or more locations in said telephony network.

71. The system of claim 70, wherein said signals comprise signals selected from one of a figure of merit for voice clarity, a figure of merit for voice intelligibility, a voice level, a power, a timing signal, or a delay.

72. The system of claim 70, wherein said signals comprise a signal obtained from a selected one of a telephone handset, a telephone base unit, a line card, an FXS port, and FXO port, an E&M port, a T1/E1/J1 digital trunk, an Ethernet port, audio in and out ports, or a router.

73. The system of claim 70, wherein said signals comprise a signal obtained from a telephone handset and a signal obtained from a non-telephone device connected to a communication channel.

74. The system of claim 61, further comprising a recording subsystem that records a selected one of a DC impedance, an AC impedance, a noise, an echo, a waveform, a timing signal, or a line event.

75. The system of claim 74, wherein said recording subsystem comprises a nonvolatile memory that maintains a record of a selected one of a DC impedance, an AC impedance, a noise, an echo, a waveform, a timing signal, or a line event.

76. The system of claim 61, further comprising a reproduction subsystem that reproduces from a record a selected one of a DC impedance, an AC impedance, a noise, an echo, a waveform, a timing signal, or a line event.

77. The system of claim 61, further comprising a synchronizing subsystem that synchronizes a first selected one of a waveform, a timing signal, or a line event with a second selected one of a waveform, a timing signal, or a line event.

78. The system of claim 61, wherein the computer system comprises a modeling subsystem that models mathematically a parameter of a programmable telephone equipment, said parameter selected from one of a DC impedance, an AC impedance, a noise, an echo, a waveform, a timing signal, or a line event, said modeling subsystem calculating an improvement in performance of said programmable telephone equipment in response to a change in a programmable characteristic of said telephone equipment.

79. The system of claim 61, further comprising:
a transmitter subsystem that sends over the telephony network information about a selected one of a figure of merit for voice clarity, a figure of merit for voice intelligibility, a voice level, a power, a timing signal, a delay, a DC impedance, all AC impedance, a noise, an echo, a waveform, a line event, an AC call-control signal, a DC call-control signal, a call progress tone, or a CLASS signal.

80. The system of claim 79, further comprising a tone and waveform generator that sends tones and selected waveforms over the telephony network.

81. The system of claim 79, further comprising a synchronizing subsystem that synchronizes a first selected one of a tone, a waveform, a timing signal, or a line event with a second selected one of a tone, a waveform, a timing signal, or a line event.

82. The system of claim 79, further comprising a recorder that records speech and signals.

83. The system of claim 79, further comprising a digitizer that digitizes recorded speech and signals.

84. The system of claim 79, further comprising a scheduler that commands the transmitter to transmit said digitized recorded speech and signals as a file, said scheduler controlling and recording the time of transmission of said file so that a delay and a degradation of said signal in one-way transmission can be analyzed.

85. The system of claim 79, further comprising:
a recorder that records speech and signals;
a digitizer that digitizes recorded speech and signals; and
a scheduler that commands the transmitter to transmit said digitized recorded speech and signals as a file, said scheduler controlling and recording the time of transmission of said file, so that a delay and a degradation of said signal in one-way transmission can be analyzed.

86. The system of claim 79, further comprising:
a second transmitter that can generate a second call using a second network;
a second analyzer that measures quality of service of a signal transmitted over said second network, said second analyzer comprising:
a computer system;
a configuration subsystem that configures said computer system to interface with said second network;
an quality of service analysis subsystem that performs an analysis of said quality of service of said signal;
a report generator that reports a result of said analysis; and
a comparator that compares the relative performance of the telephony network and said second network.

87. The system of claim 86, wherein said second transmitter comprises a transmitter that repeatedly generates said test calls and said second analyzer comprises an analyzer that repeatedly analyzes said test calls to monitor during a telephone call whether a significant change in quality of service takes place.

88. The system of claim 61, further comprising a routing selector that selects a route based at least in part on said quality of service measurement.

89. The system of claim 61, further comprising:
a receiver subsystem that receives over the telephony network information about a selected one of a figure of merit for voice clarity, a figure of merit for voice intelligibility, a voice level, a power, a timing signal, a delay, a DC impedance, an AC impedance, a noise, an echo, a waveform, a line event, an AC call-control signal, a DC call-control signal, a call progress tone and a CLASS signal.

90. The system of claim 89, further comprising a receiver that detects and recognizes tones and selected waveforms transmitted over the telephony network.

91. The system of claim 89, further comprising a synchronization detector that determines a synchronization between a first selected one of a tone, a waveform, a timing signal, or a line event with a second selected one of a tone, a waveform, a timing signal, or a line event.

92. The system of claim 89, further comprising a speech measurement subsystem that measures quality of service of a signal representative of speech.

93. The system of claim 89, further comprising a signal measurement subsystem that measures signal levels.

94. The system of claim 89, further comprising an analyzer that detects and analyzes DTMF signals.

95. The system of claim 89, further comprising a display subsystem that reports a selected result of one of quality of service measurement, signal level measurement, and signal type analysis.

96. The system of claim 89, further comprising:
a speech measurement subsystem that measures quality of service of a signal representative of speech;
a signal measurement subsystem that measures signal levels;
an analyzer that detects and analyzes DTMF signals; and
a display subsystem that reports a selected result of one of quality of service measurement, signal level measurement, and signal type analysis.

97. The system of claim 89, further comprising:
a second receiver that can accept a second call transmitted over a second network;
a second analyzer that measures quality of service of a signal transmitted over said second network

98. The system of claim 97, wherein said second analyzer comprises a comparator that compares the relative performance of the telephony network and said second network.

99. The system of claim 97 wherein said second receiver comprises an receiver that repeatedly receives said test calls and said second analyzer comprises an analyzer that repeatedly analyzes said test calls to monitor during a telephone call whether a significant change in quality of service takes place.

100. The system of claim 89, further comprising a routing selector that selects a route based at least in part on said quality of service measurement.

101. A system for analyzing adherence to a communication protocol, said system comprising:
a connector adapted to make a connection to a test point in the telephony network; and
an analyzer that analyzes adherence to a communication protocol at said test point, said analyzer comprising:
a computer system;
a configuration subsystem that configures said computer system to interface with said telephony network;
a communications protocol analysis subsystem that performs an analysis of adherence to said communication protocol; and
a report generator that reports a result of said communication protocol analysis.

102. The system of claim 101, wherein said system is a personal computer system comprising hardware and software components.

103. The system of claim 101, wherein said connector is a handset connector that couples to a telephone handset to make said connection.

104. The system of claim 101, wherein said connector is a base connector that couples to a telephone base to make said connection.

105. The system of claim 101, further comprising a recorder that records signals transmitted by the telephony network at said test point.

106. The system of claim 105, further comprising a reproduction unit that reproduces the recorded signal through the telephony network at said test point to permit an analysis of adherence to said communication protocol.

107. The system of claim 101, wherein said communication protocol analysis subsystem comprises a subsystem that tests an adherence to a communication protocol selected from an Internet protocol, a voice over Internet protocol, voice over frame relay, voice over asynchronous transfer mode, voice over digital subscriber line, and voice over cable.

108. The system of claim 101, wherein said connector comprises a connector adapted to connect to a selected one of a telephone handset, a telephone base unit, a line card, an FXS port, and FXO port, an E&M port, a T1/E1/J1 digital trunk, an Ethernet port, audio in and out ports, or a router.

109. The system of claim 101, further comprising a comparison subsystem that compares adherence to a communication protocol as used in two or more locations in said telephony network.

110. The system of claim 109, wherein said communication protocol is selected from one of an Internet protocol, a voice over Internet protocol, voice over frame relay, voice over asynchronous transfer mode, voice over digital subscriber line, and voice over cable.

111. The system of claim 109, where in said communication protocol is analyzed from a selected one of a telephone handset, a telephone base unit, a line card, an FXS port, and FXO port, an E&M port, a T1/E1/J1 digital trunk, an Ethernet port, audio in and out ports, or a router.

112. The system of claim 111, wherein said communication protocol is analyzed from a telephone handset and from a non-telephone device connected to a communication channel.

113. The system of claim 101, further comprising a recording subsystem that records the analysis of the communication protocol.

114. The system of claim 113, further comprising a non-volatile memory that maintains a record of the analysis of the communication protocol.

115. The system of claim 114, further comprising a reproduction subsystem that reproduces from a record the analysis of the communication protocol.

116. The system of claim 113, wherein the computer system comprises a modeling subsystem that models mathematically the communication protocol used by a programmable telephone equipment, said modeling subsystem calculating an improvement in performance of said programmable telephone equipment in response to a change in a programmable characteristic of said telephone equipment.

117. A system for measuring quality of voice services on modern telephony networks, including VON, PSTN, and hybrid VON/PSTN networks, and for analyzing adherence to a communication protocol, said system comprising an analyzer that measures quality of service of a signal transmitted over the telephony network and analyzes adherence to a communication protocol at a test point in the telephony network.

118. The system of claim 117, further comprising a connector adapted to make a connection to said test point in the telephony network.

119. The system of claim 117, wherein said analyzer comprises a computer system.

120. The system of claim 119, wherein said system is a personal computer system comprising hardware and software components.

121. The system of claim 119, wherein said analyzer further comprises a configuration subsystem that configures said computer system to interface with said telephony network.

122. The system of claim 117, wherein said analyzer further comprises a quality of service analysis subsystem that performs an analysis of said quality of service of said signal.

123. The system of claim 122, wherein said analyzer further comprises a report generator that reports a result of said analysis of said quality of service of said signal.

124. The system of claim 117, wherein said analyzer further comprises a communications protocol analysis subsystem that performs an analysis of adherence to said communication protocol.

125. The system of claim 124, wherein said analyzer further comprises a report generator that reports a result of said analysis of adherence to said communication protocol.

126. The system of claim 122, wherein said analyzer further comprises:
a quality of service analysis subsystem that performs an analysis of said quality of service of said signal; and
a communications protocol analysis subsystem that performs an analysis of adherence to said communication protocol.

127. The system of claim 126, wherein said analyzer further comprises a report generator that reports both a result of said analysis of said quality of service of said signal and said analysis of adherence to said communication protocol.

128. The system of claim 117, wherein said analyzer comprises:
a computer system;
a configuration subsystem that configures said computer system to interface with said telephony network;
a quality of service analysis subsystem that performs an analysis of said quality of service of said signal;
a communications protocol analysis subsystem that performs an analysis of adherence to said communication protocol; and
a report generator that reports both a result of said analysis of said quality of service of said signal and said analysis of adherence to said communication protocol.

129. The system of claim 128, wherein said system is a personal computer system comprising hardware and software components.

130. The system of claim 128, wherein said connector is a handset connector that couples to a telephone handset to make said connection.

131. The system of claim 128, wherein said connector is a base connector that couples to a telephone base to make said connection.

132. The system of claim 128, further comprising:
a recorder that records signals transmitted by the telephony network at said test point.

133. The system of claim 132, further comprising a reproduction unit that reproduces the recorded signal through the telephony network at said test point to permit a determination of a speech quality.

134. The system of claim 128, wherein said quality of service analysis subsystem comprises a subsystem that tests quality of service selected from a figure of merit for voice clarity, a figure of merit for voice intelligibility, a voice level, a power, a timing signal, or a delay.

135. The system of claim 128, wherein said quality of service analysis subsystem comprises a subsystem that tests a telephony condition selected from an AC call-control signal, a DC call-control signal, a call progress tone, or a CLASS signal.

136. The system of claim 128, wherein said communication protocol analysis subsystem comprises a subsystem that tests an adherence to a communication protocol selected from an Internet protocol, a voice over Internet protocol, voice over frame relay, voice over asynchronous transfer mode, voice over digital subscriber line, and voice over cable.

137. The system of claim 128, wherein said connector comprises a connector adapted to connect to a selected one of a telephone handset, a telephone base unit, a line card, an FXS port, and FXO port, an E&M port, a T1/E1/J1 digital trunk, an Ethernet port, audio in and out ports, or a router.

138. The system of claim 128, further comprising a comparison subsystem that compares results obtained from tests performed between two or more locations in said telephony network.

139. The system of claim 138, wherein said signals comprise signals selected from one of a figure of merit for voice clarity, a figure of merit for voice intelligibility, a voice level, a power, a timing signal, or a delay.

140. The system of claim 138, wherein said signals comprise a signal obtained from at least a selected one of a telephone handset, a telephone base unit, a line card, an FXS port, and FXO port, an E&M port, a T1/E1/J1 digital trunk, an Ethernet port, audio in and out ports, or a router.

141. The system of claim 138, wherein said signals comprise a signal obtained from a telephone handset and at least a signal obtained from a non-telephone device connected to a communication channel.

142. The system of claim 128, further comprising a recording subsystem that records a selected one of a DC impedance, an AC impedance, a noise, an echo, a waveform, a timing signal, or a line event.

143. The system of claim 128, further comprising a non-volatile memory that maintains a record of a selected one of a DC impedance, an AC impedance, a noise, an echo, a waveform, a timing signal, or a line event.

144. The system of claim 128, further comprising a reproduction subsystem that reproduces from a record a selected one of a DC impedance, an AC impedance, a noise, an echo, a waveform, a timing signal, or a line event.

145. The system of claim 128, further comprising a synchronizing subsystem that synchronizes a first selected one of a waveform, a timing signal, or a line event with a second selected one of a waveform, a timing signal, or a line event.

146. The system of claim 128, wherein the computer system comprises a modeling, subsystem that models mathematically a parameter of a programmable telephone equipment, said parameter selected from one of a DC impedance, an AC impedance, a noise, an echo, a waveform, a timing signal, or a line event, said modeling subsystem calculating an improvement in performance of said programmable telephone equipment in response to a change in a programmable characteristic of said telephone equipment.

147. The system of claim 128, further comprising a tone and waveform generator that sends tones and selected waveforms over the telephony network.

148. The system of claim 128, further comprising a synchronizing subsystem that synchronizes a first selected one of a tone, a waveform, a timing signal, or a line event with a second selected one of a tone, a waveform, a timing signal, or a line event.

149. The system of claim 128, further comprising a recorder that records speech and signals.

150. The system of claim 128, further comprising a digitizer that digitizes recorded speech and signals.

151. The system of claim 128, further comprising a transmitter subsystem that sends over the telephony network information about a selected one of a figure of merit for voice clarity, a figure of merit for voice intelligibility, a voice level, a power, a timing signal, a delay, a DC impedance, an AC impedance, a noise, an echo, a waveform, a line event, an AC call-control signal, a DC call-control signal, a call progress tone, or a CLASS signal.

152. The system of claim 151, further comprising a scheduler that commands the transmitter to transmit said digitized recorded speech and signals as a file, said scheduler controlling and recording the time of transmission of said file, so that a delay and a degradation of said signal in one-way transmission can be analyzed.

153. The system of claim 151, further comprising:
a second transmitter that can generate a second call using a second network;
a second analyzer that measures quality of service of a signal transmitted over said second network and analyzes adherence to a communication protocol at said test point

154. The system of claim 153, wherein said second analyzer comprises a comparator that compares the relative performance of the telephony network and said second network.

155. The system of claim 154, further comprising a routing selector that selects a route based at least in part on said quality of service measurement.

156. The system of claim 155 further comprising a billing subsystem that records billing information pertaining to said route selected by said routing selector.

157. The system of claim 153, wherein said second transmitter comprises a transmitter that repeatedly generates said test calls and said second analyzer comprises an analyzer that repeatedly analyzes said test calls to monitor during a telephone call whether a significant change in quality of service takes place.

158. The system of claim 157, further comprising a rerouting selector that selects a new route based at least in part on whether a significant change in quality of service takes place.

159. The system of claim 158, further comprising a billing subsystem that records billing information pertaining to said new route selected.

160. The system of claim 128, further comprising a receiver subsystem that receives over the telephony network information about a selected one of a figure of merit for voice clarity, a figure of merit for voice intelligibility, a voice level, a power, a timing signal, a delay, a DC impedance, an AC impedance, a noise, an echo, a waveform, a line event, an AC call-control signal, a DC call-control signal, a call progress tone and a CLASS signal.

161. The system of claim 160, further comprising a receiver that detects and recognizes tones and selected waveforms transmitted over the telephony network.

162. The system of claim 161, further comprising a synchronization detector that determines a synchronization between a first selected one of a tone, a waveform, a timing signal, or a line event with a second selected one of a tone, a waveform, a timing signal, or a line event.

163. The system of claim 160, further comprising a speech measurement subsystem that measures quality of service of a signal representative of speech.

164. The system of claim 160, further comprising a signal measurement subsystem that measures signal levels.

165. The system of claim 160, further comprising an analyzer that detects and analyzes DTMF signals.

166. The system of claim 160, further comprising a display subsystem that reports a selected result of one of quality of service measurement, signal level measurement, and signal type analysis.

167. The system of claim 160, further comprising:
a speech measurement subsystem that measures quality of service of a signal representative of speech;
a signal measurement subsystem that measures signal levels; an analyzer that detects and analyzes DTMF signals; and
a display subsystem that reports a selected result of one of quality of service measurement, signal level measurement, and signal type analysis.

168. The system of claim 160, further comprising a second receiver that can accept a second call transmitted over a second network.

169. The system of claim 168, further comprising a second analyzer that measures quality of service of a signal transmitted over said second network and analyzes adherence to a communication protocol at said test point.

170. The system of claim 169, further comprising a comparator that compares the relative performance of the telephony network and said second network.

171. The system of claim 170 wherein said second receiver comprises an receiver that repeatedly receives said test calls and said second analyzer comprises an analyzer that repeatedly analyzes said test calls to monitor during a telephone call whether a significant change in quality of service takes place.

172. The system of claim 171, further comprising a rerouting selector that selects a new route based at least in part on whether a significant change in quality of service takes place.

173. The system of claim 160, further comprising a routing, selector that selects a route based at least in part on said quality of service measurement.

174. The system of claim 128, further comprising a billing subsystem that records billing information pertaining to the communications network.

175. The system of claim 128, further comprising a routing selector that selects a route based at least in part on said quality of service measurement.

176. The system of claim 175 further comprising a billing subsystem that records billing information pertaining to said route selected by said routing selector.

177. The system of claim 128, further comprising a rerouting selector that selects a new route based at least in part on whether a significant change in quality of service takes place.

178. The system of claim 177, further comprising a billing subsystem that records billing information pertaining to said new route selected.

179. A method of testing quality of voice services from a source node to a destination node over a modem telephony network using at least two testers wherein a first tester is located at said source node and wherein a second tester is located at said destination node, said method comprising:
said first tester initiating a telephone call from the first tester to the second tester;
said first tester analyzing call progress tones in order to determine if the call is completed;
said first tester measuring the time from a dialing event by the first tester to an answer event by said second tester;
said first tester transmitting tones to said second tester for a purpose of enabling the second tester to receive said tones, analyze said tones, and determine the quality of transmission for said tones;
said first tester transmitting a plurality of reference wave files to said second tester for a purpose of enabling the second tester to receive said files, analyze said files, and determine the quality of transmission for said files;
said second tester transmitting tones to said first tester for a purpose of enabling the first tester to receive said tones, analyze said tones, and determine the quality of transmission for said tones;
said second tester transmitting a plurality of reference wave files to said first tester for a purpose of enabling the first tester to receive said files, analyze said files, and determine the quality of transmission for said files;
said first tester calculating a first score for the quality of said tones and said files said first tester received from the second tester;
said second tester calculating a second score for the quality of said tones and said files that said second tester received from said first tester;
said second tester sending to said first tester said second score and said first tester receiving from the second tester said score;
said first tester calculating an overall score for quality of voice service based at least in part on at least one of an attribute from a group of attributes comprising said first score, said second score, said time from said dialing event by the first tester to said answer event by said second tester; and
said first tester displaying said overall score on one of a peripheral group comprising a computer screen, a printer, an external communication device, a computer storage device, or a remote computer.

180. The method of claim 179, further comprising:
said first tester initiating a second telephone call on a second network from the first tester to the second tester;
said first tester analyzing said second call progress tones in order to determine if said second call call is completed;
said first tester measuring the time from a second dialing event by the first tester to a second answer event by said second tester;
said first tester transmitting tones over the second network to said second tester for a purpose of enabling the second tester to receive said tones, analyze said tones, and determine the quality of transmission for said tones;
said first tester transmitting a plurality of reference wave files to said second tester over the second network for a purpose of enabling the second tester to receive said files, analyze said files, and determine the quality of transmission for said files;
said second tester transmitting tones to said first tester over the second network for a purpose of enabling the first tester to receive said tones, analyze said tones, and determine the quality of transmission for said tones;
said second tester transmitting a plurality of reference wave files to said first tester over the second network for a purpose of enabling the first tester to receive said files, analyze said files, and determine the quality of transmission for said files;
said first tester calculating a third score for the quality of said tones and said files said first tester received from the second tester over the second network;
said second tester calculating a fourth score for the quality of said tones and said files that said second tester received from said first tester over the second network;
said second tester sending to said first tester said fourth score over the second network and said first tester receiving from the second tester said score;
said first tester calculating a second overall score for quality of voice service on said second network based at least in part on at least one of an attribute from a group of attributes comprising said third score, said fourth score, said time from said dialing event by the first tester to said answer event by said second tester over said second network; and
said first testing routing at least one subsequent call through said network or said second network based at least in part on a comparison of the overall score and the second overall score.

181. A method of testing quality of voice services over a digital telephone, said method comprising:
disconnecting the telephone base unit from the telephone handset, connecting said telephone handset to said tester, and connecting said tester to said telephone base via said telephone base unit's handset port;
said tester operating in a pass-through mode to enables normal operation between said telephone handset and said telephone base unit;
placing a test call via said telephone base unit;
said tester measuring signal levels of transmit signals and a receive signals at the handset port of said telephone base unit;
said tester determining the optimum signal parameters for simulating said telephone handset;
disconnecting said telephone handset from said tester;
said tester simulating the impedance of the telephone handset based on the measured parameters;
said tester generating test signals through the handset port of the telephone base unit;
said tester generating test wave files through the handset port of the telephone base unit;
said tester measuring signal said test signals and said files that are received through the telephone base unit; and
disconnecting the telephone base unit from said tester and reconnecting said telephone handset to the telephone base unit.

182. A method of using a communication tester to monitor quality of voice services as perceived by a caller, said method comprising:
interfacing said tester to a telephone line used by at least one caller without affecting the quality of the call or noticeably changing the level of transmitted signals and received signals;
monitoring dialed DTMF digits and storing them in a tester memory;
monitoring call progress tones and determining whether or not a call is connected;
measuring a time from an end of dialing to a first ringback.
recording a voice communication in a plurality of consecutive short-duration time divisions;
performing Digital Signal Processing to determine impairments such as echo, delay, crosstalk, or distortion;
performing speech recognition using DSP techniques to look for phrases that indicate difficulty with the call such “hello . . . hello . . . ,” “speak up . . . ,” or “I can't hear you . . .” as an indication of a problem with said call; and
generating a statistical log that includes at least one item of information such as a date and a time of said call, call duration, call quality for each measured sample period, or key words detected that indicate a problem; and
reporting statistics to a computer either in response to a request by such a computer or at pre-programmed times.

183. The method of claim 182, further comprising the element of monitoring said call for a sudden degradation in quality of service during said call and relaying information about any such degradation real-time to a service provider for corrective action.

184. The method of claim 182, further comprising the element of monitoring said call for a sudden degradation in quality during said call and relaying information about any such degradation to a call routing system having the means to handoff said call to another carrier while said call remains in progress.

185. The method of claim 182, further comprising the element of monitoring said call for a DTMF string entered by a caller on said caller via a pushbutton keypad on a telephone indicating call quality is unsatisfactory and relaying information about any such DTMF string to a call routing system having the means to handoff said call to another carrier while said call remains in progress.

186. A system for measuring quality of voice services on modem telephony networks, including VON, PSTN, and hybrid VON/PSTN networks, and for analyzing adherence to a communication protocol, said system comprising:
a connector adapted to make a connection to a test point in the telephony network, said connector adapted to connect to at least a selected one of a telephone handset, a telephone base unit, a line card, an FXS port, and FXO port, an E&M port, a T1/E1/J1 digital trunk, an Ethernet port, audio in and out ports, or a router.
an analyzer that measures quality of service of a signal transmitted over the telephony network and analyzes adherence to a communication protocol at said test point, said analyzer comprising:
a computer system;
a configuration subsystem that configures said computer system to interface with said telephony network;
a tone and waveform generator that sends tones and selected waveforms over the telephony network; and
a synchronizing subsystem that synchronizes a first selected one of a tone, a waveform, a timing signal, or a line event with a second selected one of a tone, a waveform, a timing signal, or a line event;
a transmitter subsystem that sends over the telephony network information about a selected one of a figure of merit for voice clarity, a figure of merit for voice intelligibility, a voice level, a power, a timing signal, a delay, a DC impedance, an AC impedance, a noise, an echo, a waveform, a line event, an AC call-control signal, a DC call-control signal, a call progress tone, or a CLASS signal;
a scheduler that commands the transmitter subsystem to transmit said digitized recorded speech and signals as a file, said scheduler controlling and recording a time of transmission of said file so that a delay and a degradation of said signal in one-way transmission can be analyzed;
a receiver that detects and recognizes tones and selected waveforms transmitted over the telephony network and comprising a receiver subsystem that receives over the telephony network information about a selected one of a figure of merit for voice clarity, a figure of merit for voice intelligibility, a voice level, a power, a timing signal, a delay, a DC impedance, an AC impedance, a noise, an echo, a waveform, a line event, an AC call-control signal, a DC call-control signal, a call progress tone, or a CLASS signal;
a synchronization detector that determines a synchronization between a first selected one of a tone, a waveform, a timing signal, or a line event with a second selected one of a tone, a waveform, a timing signal, or a line event;
a recorder that records speech and signals transmitted by the telephony network at said test point, said recorder comprising non-volatile memory;
a recording subsystem that records a selected one of a DC impedance, an AC impedance, a noise, an echo, a waveform, a timing signal, or a line event, said recording subsystem comprising a non-volatile memory that maintains a record of at least one of a DC impedance, an AC impedance, a noise, an echo, a waveform, a timing signal, or a line event;
a reproduction unit that reproduces recorded signal through the telephony network at said test point to permit a determination of a speech quality, said reproduction unit further comprising a reproduction subsystem that reproduces from a record a selected one of a DC impedance, an AC impedance, a noise, an echo, a waveform, a timing signal, or a line event;
a modeling subsystem that models mathematically a parameter of a programmable telephone equipment, said parameter selected from one of a DC impedance, an AC impedance, a noise, an echo, a waveform, a timing signal, or a line event, said modeling subsystem calculating an improvement in performance of said programmable telephone equipment in response to a change in a programmable characteristic of said telephone equipment;
a quality of service analysis subsystem that performs an analysis of said quality of service of said signal, said quality of service analysis subsystem comprising: (a) a subsystem that tests quality of service selected from a figure of merit for voice clarity, voice intelligibility, a voice level, a power, a timing signal, or a delay; and (b) a subsystem that tests a telephony condition selected from an AC call-control signal, a DC call-control signal, a call progress tone, or a CLASS signal;
a communications protocol analysis subsystem that performs an analysis of adherence to said communication protocol, said communications protocol analysis subsystem comprising a subsystem that tests an adherence to a communication protocol selected from an Internet protocol, a voice over Internet protocol, voice over frame relay, voice over asynchronous transfer mode, voice over digital subscriber line, or voice over cable;
a speech measurement subsystem that measures quality of service of a signal representative of speech;
a signal measurement subsystem that measures signal levels;
a report generator that reports both a result of said analysis of said quality of service of said signal and said analysis of adherence to said communication protocol
a signal analyzer that detects and analyzes DTMF signals;
a display subsystem that reports a selected result of at least one from quality of service measurement, signal level measurement, or signal type analysis; and
a comparison subsystem that compares results obtained from tests performed between two or more locations in said telephony network, wherein: (a) said signals comprise signals selected from one of a figure of merit for voice clarity, a figure of merit for voice intelligibility, a voice level, a power, a timing signal, or a delay; (b) one of said signals comprise a signal obtained from a telephone handset; and (c) a second of said signals comprise a signal obtained from a selected one of a telephone base unit, a line card, an FXS port, and FXO port, an E&M port, a T1/E1/J1 digital trunk, an Ethernet port, audio in and out ports, a router, or from a non-telephone device connected to a communication channel;
a second analyzer that measures quality of service of a signal transmitted over said second network and analyzes adherence to a communication protocol at said test point wherein said second analyzer repeatedly analyzes said test calls to monitor during a telephone call whether a significant change in quality of service takes place, said second analyzer comprising:
a second transmitter that can generate a second call using a second network wherein said second transmitter comprises a transmitter that repeatedly generates said test calls; and
a second receiver that can accept a second call transmitted over a second network wherein said second receiver comprises a receiver that repeatedly receives said test calls;
a routing selector that selects a route based at least in part on said quality of service measurement;
a rerouting selector that selects a new route based at least in part on whether a significant change in quality of service takes place;
a billing subsystem that records billing information pertaining to at least one selected from a route selected by said routing selector, a reroute selected, or other carrier billing information;
a connector adapted for a non-intrusive, high-impedance interface to said telephony network;
a high-impedance measurement subsystem capable of measuring quality of voice services passing through each said node on each said telephony network;
a quality of service analysis subsystem that analyzes quality of service for each said telephony network for a plurality of calls made over said telephony network through each said node;
a data store that records the analysis of the quality of service analysis subsystem;
a reporting subsystem that sends one or more said analyses of the quality of service analysis subsystem to a predetermined destination via the telephony network;
a monitoring subsystem that analyzes said recorded analyses and ascertains whether said quality of service falls below a predefined level; and
a notification subsystem whereby said analyzer system sends a message via the telephony network to a predefined destination when said quality of service falls below a predefined level;
at least one high-impedance measurement subsystem capable of measuring quality of service of each said telephony network by analyzing a voice communication passing through each said node on each said telephony network;
at least one quality of service analysis subsystem that analyzes quality of service for at least one of said telephony networks for the duration of at least one call made over said telephony networks and passing through said corresponding nodes connected to said telephony networks;
at least one switching subsystem corresponding to each quality of service analysis subsystem that, if during the course of a call said quality of service analysis subsystem detects a degradation of said quality of service on a first telephony network, said switching subsystem immediately switches the call to a second telephony network for uninterrupted servicing of said call;
at least two analyzer systems wherein each such analyzer system is connected to a node on at least two of said telephony networks, each such analyzer system comprising a system capable of measuring quality of voice services over a telephony network;
at least one testing subsystem corresponding to one said analyzer system by which such analyzer system initiates at least two calls over at least two of said telephony networks to at least one other analyzer system and analyzes the quality of voice services between said first analyzer system and said second analyzer system over said telephony networks over which said calls were made;
at least one selection subsystem corresponding to each testing subsystem by which said corresponding analyzer system can select one telephony network from among the plurality of telephony networks tested for routing at least one call through said node corresponding to said corresponding analyzer system to another node, said selection based at least in part on an evaluation of said analyses by said corresponding testing subsystem; and
at least one circuit-switched network wherein said analyzer system is connected to at least one node corresponding to said circuit-switched network and wherein said system can select said circuit-switched network in lieu of said telephony networks.
